(19) United States
(12) Patent Application Publication
(10) Pub. No.: US 2026/0314716 A1
(43) Pub. Date: Oct. 15, 2026

(54) Garments Including Inflatable Components

(71) Applicant: NIKE, Inc., Beaverton, OR (US)

(72) Inventors: Montserrat Ciges Lopez, Portland, OR (US); Merav Gazit, Portland, OR (US); Chloe Kov, Beaverton, OR (US); Nick Galluzzo, Beaverton, OR (US); Simon Quay, Portland, OR (US)

(21) Appl. No.: 19/642,532

(22) Filed: Apr. 8, 2026

Related U.S. Application Data
(60) Provisional application No. 63/786,186, filed on Apr. 9, 2025.
(60) Provisional application No. 63/786,188, filed on Apr. 9, 2025.

(51) Int. Cl. A41D 13/005; A41D 31/06

(52) U.S. Cl. CPC A41D 13/005; A41D 31/06; A41D 2400/14

(57) ABSTRACT

Garment components include one or more fluid-filled bladder chambers. The bladder chamber(s) may be convertible between a deflated condition and an inflated condition. In some examples, garment components may include a tether member having one or more layers within the bladder chamber of the garment component. Connections of the tether member with the garment’s interior-most layer and/or exterior-most layer and/or connections between layers of the tether member (if multi-layered) can be varied to control shape and configuration of the garment component when inflated. Additionally or alternatively, when a garment component is formed to include a transparent, partially transparent, and/or translucent component, variations in the above connections and/or variations in openings provided through the tether member may be varied to alter the visual appearance of the garment component when transitioning between the deflated configuration and an inflated configuration.

### RELATED APPLICATION DATA

This application is a U.S. Non-Provisional Application and claims priority benefits based on: (A) U.S. Provisional Patent Appln. No. 63/786,186 filed Apr. 9, 2025 and entitled “Garments Including Inflatable Components,” and (B) U.S. Provisional Patent Appln. No. 63/786,188 filed Apr. 9, 2025 and entitled “Garments Including Inflatable Components.” Each of U.S. Provisional Patent Appln. No. 63/786,186 and U.S. Provisional Patent Appln. No. 63/786,188 is entirely incorporated herein by reference.

Aspects of the present technology may be used in conjunction with laminates, bladders, and/or garment components of the types described in one or more of: (a) U.S. Provisional Patent Appln. No. 63/677,693 filed Jul. 31, 2024 and entitled “Laminates, Bladders, and Garments Including Laminates and Bladders,” (b) U.S. Provisional Patent Appln. No. 63/677,708 filed Jul. 31, 2024 and entitled “Laminates, Bladders, and Garments Including Laminates and Bladders,” (c) U.S. Provisional Patent Appln. No. 63/677,842 filed Jul. 31, 2024 and entitled “Laminates, Bladders, and Garments Including Laminates and Bladders,” (d) U.S. Provisional Patent Appln. No. 63/677,870 filed Jul. 31, 2024 and entitled “Laminates, Bladders, and Garments Including Laminates and Bladders,” (e) U.S. Provisional Patent Appln. No. 63/726,392 filed Nov. 29, 2024 and entitled “Laminates, Bladders, and Garments Including Laminates and Bladders,” (f) U.S. Provisional Patent Appln. No. 63/726,394 filed Nov. 29, 2024 and entitled “Laminates, Bladders, and Garments Including Laminates and Bladders,” (g) U.S. Provisional Patent Appln. No. 63/726,399 filed Nov. 29, 2024 and entitled “Laminates, Bladders, and Garments Including Laminates and Bladders,” (h) U.S. Provisional Patent Appln. No. 63/726,427 filed Nov. 29, 2024 and entitled “Laminates, Bladders, and Garments Including Laminates and Bladders,” and (i) U.S. Provisional Patent Appln. No. 63/786,188 filed Apr. 9, 2025 and entitled “Garments Including Inflatable Components.” Each of U.S. Provisional Patent Appln. No. 63/677,693, U.S. Provisional Patent Appln. No. 63/677,708, U.S. Provisional Patent Appln. No. 63/677,842, U.S. Provisional Patent Appln. No. 63/677,870, U.S. Provisional Patent Appln. No. 63/726,392, U.S. Provisional Patent Appln. No. 63/726,394, U.S. Provisional Patent Appln. No. 63/726,399, and U.S. Provisional Patent Appln. No. 63/726,427 is entirely incorporated herein by reference.

### FIELD OF THE INVENTION

The present invention relates to garment components and garments that include inflatable components (e.g., with laminates and bladders) and/or to methods of making and/or using such garment components and garments. In some aspects of this technology, garment components and garments will include inflatable bladder chambers configured to provide thermal insulation for the wearer and/or to provide varying color combinations and/or displays.

### BACKGROUND

Conventional articles of apparel for providing warmth include garments such as jackets, vest, coats, and the like. Such garments typically are made from heavy materials, such as wool, fleece, or the like, and/or include insulation, such as down, polymeric fillers, etc. While potentially effective at keeping the wearer warm, some conventional garments of these types can restrict motion, e.g., particularly if worn during athletic activities.

Some conventional garments of these types can become heavier and/or experience reduced effectiveness, e.g., particularly when worn in wet conditions and/or when the fabric or insulation otherwise becomes damp or wet. These factors can result in decreased effectiveness of the garment, especially for wearers engaged in athletic activities.

### SUMMARY

This Summary is provided to introduce some general concepts relating to this technology in a simplified form that are further described below in the Detailed Description. This Summary is not intended to identify key features or essential features of the invention.

Aspects of this technology relate to garment components and garments that include inflatable components (e.g., garment and garment components that include laminates and bladders). In some aspects of this technology, garment components and garments will include inflatable bladder chambers configured to provide thermal insulation for the wearer and/or to provide varying color combinations and/or displays.

In some examples of this technology, garment components may include a tether member having one or more layers within an inflatable bladder chamber of the garment. Connections of the tether member with the garment’s interior-most layer and/or exterior-most layer and/or connections between layers of the tether member (if multi-layered) can be varied to control shape and configuration of the garment component when inflated. Additionally or alternatively, when a garment component is formed to include a transparent, partially transparent, and/or translucent component, variations in the above connections and/or variations in openings provided through the tether member may be provided to alter the visual appearance of the garment component, e.g., when transitioning between the deflated configuration and an inflated configuration.

While aspects of this technology are described in terms of laminates, bladders made from one or more laminates, garment components and garments including one or more of such laminates and bladders, additional aspects of this technology relate to methods of making and/or using such laminates, bladders, garment components and garments.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIGS. 1A-1F illustrate various views and various features of garment components and garments in accordance with some examples of this technology.

FIGS. 2-4 illustrate portions of example garments or garment components formed from multi-layered laminate components.

FIGS. 5A-5E illustrate features of example garment components having a single sheet layer as a tether member.

FIGS. 6A-6F illustrate features of example garment components having a two layered (two sheet) tether member.

FIG. 7 illustrates features of example garment components having multiple tether member layers.

FIGS. 8A-8D illustrate features of example garment components when transitioning between a deflated configuration and an inflated configuration.

FIG. 9 illustrates additional alternative bonding features in garment components in accordance with some examples of this technology.

FIGS. 10A and 10B illustrate additional features of garment components in accordance with some examples of this technology.

### DETAILED DESCRIPTION

In the following description of various examples of garment components and garments according to the present technology, reference is made to the accompanying drawings, which form a part hereof, and in which are shown by way of illustration various example structures and environments in which aspects of this technology may be practiced. It is to be understood that other structures and environments may be utilized and that structural and functional modifications may be made to the specifically described structures, functions, and methods without departing from the scope of the present disclosure.

This application and/or claims use the adjectives, e.g., “first,” “second,” “third,” and the like, to identify certain components and/or features relating to this technology. These adjectives are used merely for convenience, e.g., to assist in maintaining a distinction between components and/or features of a specific structure. Use of these adjectives should not be construed as requiring a specific order or arrangement of the components and/or features being discussed. Also, use of these specific adjectives in the specification for a specific structure does not require that the same adjective be used in the claims to refer to the same part (e.g., a component or feature referred to as the “third” in the specification may correspond to any numerical adjective used for that component or feature in the claims).

This application describes components (e.g., garment components (including fabric components and laminated components), bladder components, film layers, and the like) that are “bonded” together. The term “bonded” (and derivatives thereof) means that the components are joined securely to one another. The term “bonded” encompasses bonds formed using adhesives or cements (including hot melt adhesives) as well as bonds formed in an “adhesive-free” manner, i.e., without use of a separate adhesive component.

“Adhesive-free” bonds include: bonds formed by fusing or melting components together (e.g., if the components include compositions that are compatible to mix and join together to form a bond, such as two components including a thermoplastic polyurethane (“TPU”) component); bonds formed by welding techniques (e.g., RF welding, ultrasonic welding, high-frequency welding, laser welding, impulse welding, etc.); bonds formed by heat sealing (e.g., by applying heat and optionally, pressure); etc. Some adhesive-free bonds may form a seamless joint between the two previously separate components (e.g., the materials may mix and join together and then re-harden with no discernible junction).

The term “melt bond” and variations thereof, as used herein, mean bonds formed where localized melting of each component occurs (e.g., melting of the thermoplastic polymer present in each component), the melted components combine together, and then the combined components harden to thereby “fuse” and “bond” the two components together. Such melt bonded joints are adhesive-free and may be seamless.

The term “engaged with” is used herein as a generic term and includes both adhesive based bonds and adhesive-free bonds within its scope as well as other potential types of engagement that fix two (or more) components together in a “non-bonded” manner (including through the use of mechanical connectors or fasteners, through the use of sewing or stitching, etc.).

The term “fluid impervious” as used herein means that the noted component (e.g., a film, a laminated component, a bonded region, a seam, a surface, a bladder, a garment component, a garment, etc.) is capable of stopping or reducing a rate at which air passes from one side of the component to the other side of the component. “Fluid impervious” chambers, bladders, garment components, and/or garments in accordance with at least some examples of this technology will maintain an inflated condition (holding air at a pressure above atmospheric pressure) for at least 10 minutes. While some gas may leak out of or diffuse through a “fluid impervious” component over time, the component may be considered “fluid impervious” if it can maintain an inflated condition (with the contained air at a pressure above atmospheric pressure) for at least about 10 minutes.

Given the general description of features, examples, aspects, structures, and methods according to examples of this technology provided above, a more detailed description of specific example laminates, bladder structures, garment components, garments, and methods in accordance with this technology follows.

### I. Detailed Description of Example Garment Components, Garments, and Methods According to this Technology

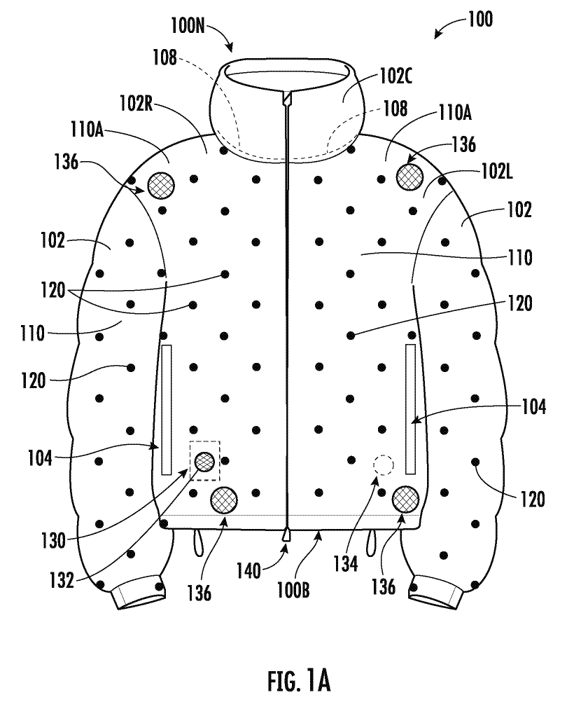

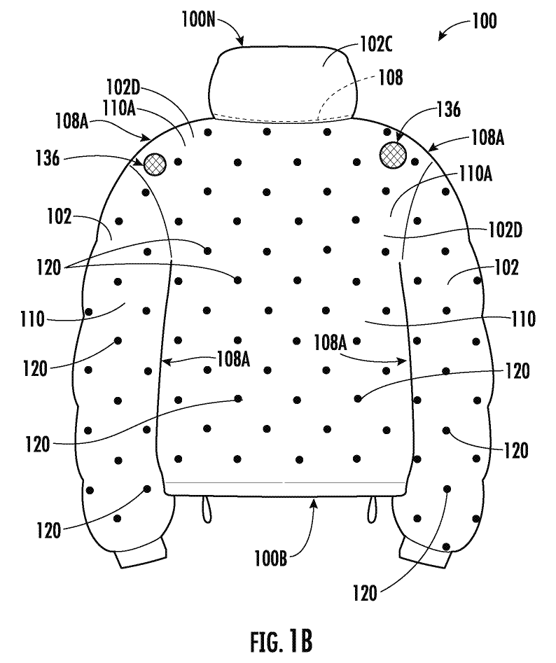

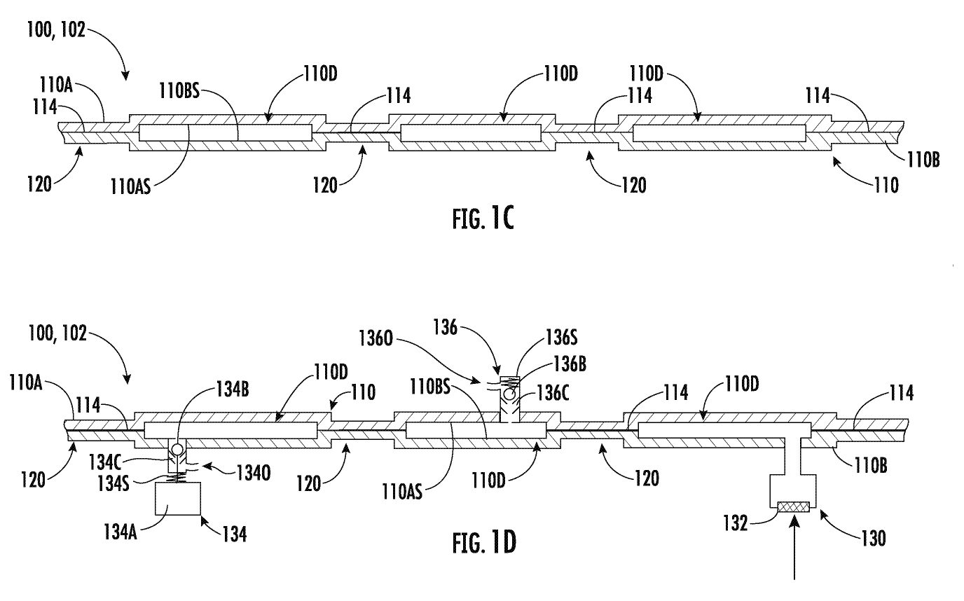

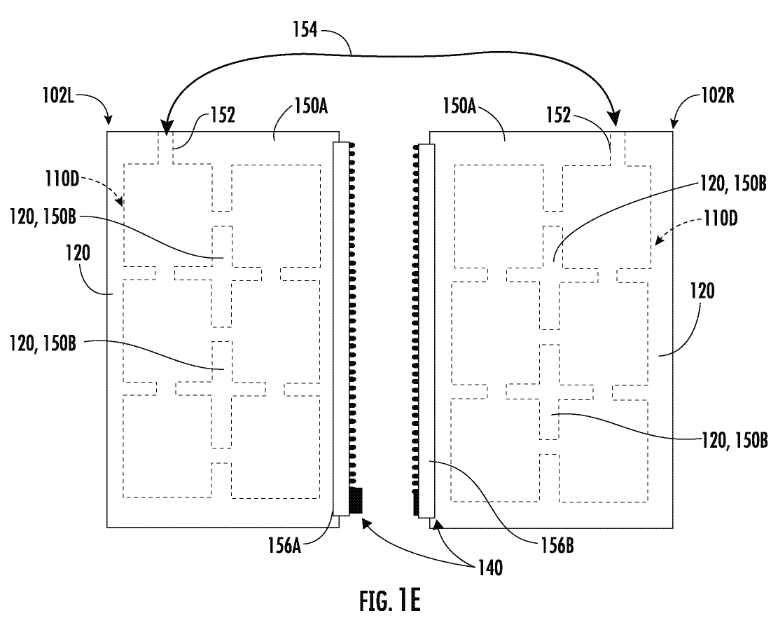

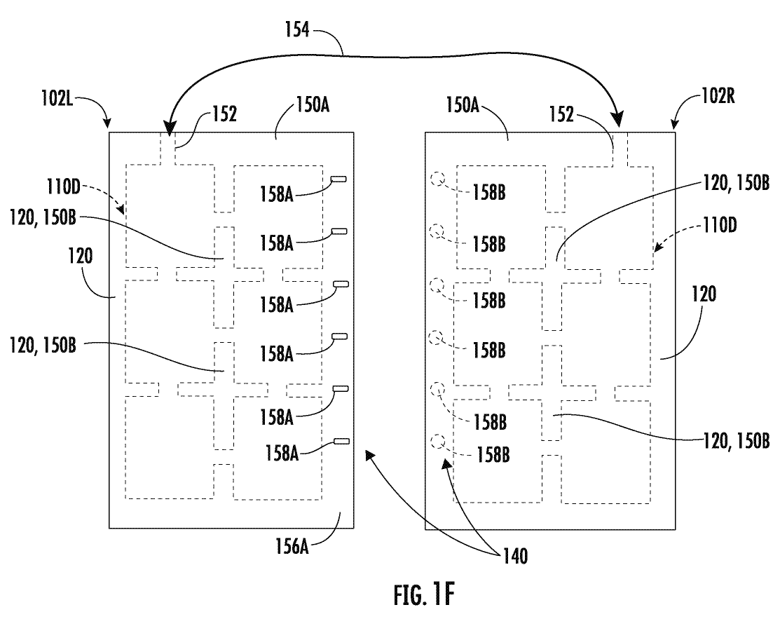

FIGS. 1A-1F show various features of garments 100 in accordance with some aspects of this technology. More specifically: FIG. 1A provides a front view of a garment 100 including one or more garment components 102 that include an inflatable bladder chamber 110 (a sealed and fluid impervious chamber configured to contain a fluid under pressure); FIG. 1B provides a back view of the garment; FIG. 1C provides a partial cross-sectional view of a bladder chamber 110 of a garment component 102 showing bonded regions 120 and inflatable chamber portions 110D; FIG. 1D provides a partial cross sectional view of a bladder chamber 110 of a garment component 102 showing other potential features; and FIGS. 1E and 1F provide views illustrating features of incorporating a securing system 140 into garments 100 according to some examples of this technology. FIGS. 1A-1F also provide information useful for understanding features of garment components that have inflatable bladder chambers that may be used in other examples of this technology.

The specific example garment 100 of FIGS. 1A and 1B is formed as a jacket or coat, but other types of garments may be formed in other specific examples of this technology, such as a jacket with a hood, a vest, a shirt, another type of upper body garment, another type of garment including an upper body portion, a lower body garment, a garment having a lower body portion, a footwear upper, etc. The garments 100 may be converted between a deflated condition (with inflatable bladder chamber 110 and bladder chamber portions 110D substantially emptied and/or flat) and an inflated condition (with inflatable bladder chamber 110 and bladder chamber portions 110D containing a gas (e.g., air) under pressure).

When in the inflated condition, garments 100 in accordance with aspects of this technology will provide increased thermal insulative properties as compared to the same garment 100 in the deflated condition.

Additionally or alternatively, garments 100 in accordance with aspects of this technology may provide different features (e.g., different color combinations, different graphic display features, etc.) when converting from a deflated configuration to an inflated configuration and/or when converting from an inflated configuration to a deflated configuration (e.g., a color or graphic reveal as a result of inflation or deflation, etc.).

In some examples, the level of inflation of a garment 100 (e.g., the volume of air introduced, the pressure of the air within the bladder chamber 110, etc.) may be varied and/or controlled. As some more specific examples, different levels of inflation of a garment 100 may correlate to different thermal resistivities associated with the garment 100 and/or different thicknesses of the layer of air provided in the bladder chamber 110D. In garments having these inflatable bladder features, a wearer may be able to control and vary the level of thermal resistivity of the garment 100.

Garments 100 in accordance with at least some aspects of this technology may be washable and reusable. The garments 100 may be formed from one or more garment components 102 that include an inflatable bladder chamber 110 or a portion thereof, as will be described in more detail below. The garments 100 may be made from different numbers of garment components 102 that include an inflatable bladder chamber 110, e.g., including from one such garment component 102 (e.g., forming a front, back, and/or sides of the garment 100) to ten or more such garment components 102. When made from multiple garment components 102 including inflatable bladder chambers 110, at least some of the inflatable bladder chambers 110 of the different garment components 102 may be interconnected and in fluid communication.

Alternatively, in some examples of this technology, when made from multiple garment components 102 that include inflatable bladder chambers 110, one or more garment component 102 having an inflatable bladder chamber 110 may be in fluid isolation from one or more other garment components 102 having an inflatable bladder chamber 110D in the overall garment 100 structure. In such garments 100, one garment component 102 may be in an inflated condition while one or more other garment components 102 is/are in a deflated condition and/or one garment component 102 may be in a deflated condition while one or more other garment components 102 is/are in an inflated condition.

Additionally or alternatively, one or more garment components 102 having inflatable bladder chambers 110 within a single garment 100 may be selectively and/or individually inflated or deflated, e.g., to allow selective control of and/or to provide increased thermal resistivity or decreased thermal resistivity at local areas of the garment 100. For example, in a garment 100 formed as a vest or jacket structure, the front and back of the vest or jacket may have separately inflatable garment components 102 that may be separately controllable, e.g., so that the front may be inflated while the back may be deflated and/or so that the front may be deflated while the back may be inflated. As another example, in an upper body garment with sleeves (e.g., a jacket or coat), the sleeves may be separately controllable, e.g., so that the sleeves (or each individual sleeve) may be inflated while the front and/or back garment component(s) may be deflated and/or so that the sleeves (or each individual sleeve) may be deflated while the front and/or back garment component(s) may be inflated. Many options and alternatives may be provided for providing separately inflated and/or separately inflatable garment components in a single garment structure.

The ability to independently and separately inflate and/or deflate garment components 102 located in various regions of a garment 100 can provide other advantages. For example, for garments formed as upper body garments (e.g., jackets, vests, etc.) that include inflatable bladder chambers 110D on the sides and/or sleeves (if any), deflating separate bladder chamber portions 110D located at the sides of the torso and/or at the insides of the sleeves may help the wearer’s arms hang more naturally and/or move more naturally. Additionally or alternatively, for garments formed as lower body garments (e.g., pants, shorts, etc.) that include inflatable bladder chambers 110D on the leg sleeves, deflating separate bladder chamber portions 110D located at the inner sides of the leg sleeves (e.g., between the thigh, knee, and/or calf regions at the insides of the leg sleeves) may help the wearer’s legs position more naturally and/or move more naturally. Additionally or alternatively, the above features may help reduce the arms or arm sleeves from continually rubbing against other portions of the garment and/or prevent the insides of the leg sleeves from rubbing together, potentially reducing noise and/or wear.

Garment components 102 that include inflatable bladder chambers 110 may be joined with garment components that do not include inflatable bladder chambers in accordance with at least some examples of this technology. Alternatively, at least one of the laminated components 110A and/or 110B may be replaced with a fluid impervious layer, such as one or more of a polyurethane layer and/or a thermoplastic polyurethane layer.

Garment components 102 that include an inflatable bladder chamber 110 may be made from two laminated components in some examples of this technology—an exterior laminated component 110A and an interior laminated component 110B. Note FIGS. 1C and 1D.

The exterior laminated component 110A and the interior laminated component 110B may be joined together in a manner so as to provide inflatable bladder chamber portions 110D and bonded regions 120. Bonded regions 120 may be provided at the exterior edge of a garment component 102 (e.g., at an outer perimeter of the garment component 102 and/or the bladder chamber 110) to form a seam and/or to provide fluid-impervious engagement between the exterior laminated component 110A and the interior laminated component 110B.

Additional bonded regions 120 may be provided at interior locations within the inflatable bladder chamber 110 (e.g., to control the bladder chamber 110’s shape and/or thickness when inflated).

Selective positioning of interior bonded regions 120 (for shape and/or thickness control) may provide various advantages. For example, interior bonded regions 120 may be provided in different bonding patterns and/or at different bond area densities at various local regions of the garment component 102 and/or overall garment 100. The term “bond area density” as used herein in this context, means the internal bonded area (e.g., the sum of the areas of all bonded regions 120) per unit area of the garment component 102 and/or region of interest. When inflated, the inflatable bladder chamber portion 110D of the garment component 102 or garment 100 in one area or region may inflate to a different height or thickness than the inflatable bladder chamber portion 110D in another area or region of the garment component 102 or garment 100. Adjustments and changes to the bonding patterns and/or bond area densities can be used to control the shape of a garment component 102 when inflated and/or control the thickness of the overall inflated bladder chamber 110D (e.g., a thickness from an exterior laminated component 110A to an interior laminated component 110B).

As a more specific example, for garments 100 formed as upper body garments (e.g., jackets, vests, etc.) that include inflatable bladder chambers 110D on the sides and/or sleeves (if any), reduced interior bond spacing 120 and/or a greater bond area density may be provided at the sides of the torso and/or at the insides of the sleeves. As another example, for garments formed as lower body garments (e.g., pants, shorts, etc.) that include inflatable bladder chambers 110D on the leg sleeves, reduced interior bond spacing 120 and/or a greater bond area density may be provided at the inner sides of the leg sleeves (e.g., between the thigh, knee, and/or calf regions at the insides of the leg sleeves). Reduced interior bond spacing 120 and/or greater bond area density at one or more of these areas may help reduce the inflatable bladder chamber thicknesses at these facing area, e.g., so that the wearer’s arms and/or legs are positioned and/or move more naturally. Additionally or alternatively, the reduced interior bond spacing 120 and/or a greater bond area density at these areas may help reduce the arms or arm sleeves from continually rubbing against the side regions of the garment and/or prevent the insides of the leg sleeves from rubbing together, potentially reducing noise and/or wear.

Garment components 102 having the inflatable bladder chamber 110 may extend over any desired portion or proportion of the garment 100 construction. In some specific examples, the garment component 102 and/or its inflatable bladder chamber 110 may: (a) form an entire garment 100 structure; (b) form an upper body garment including at least a front portion and/or a back portion; (c) form and connect a front bladder chamber portion located in a front portion of the garment 100 and a rear bladder chamber portion located in a back portion of the garment 100; (d) extend around at least one side of the garment 100 to form and connect a front bladder chamber portion located in a front portion of the garment 100 and a rear bladder chamber portion located in a back portion of the garment 100; (e) extend over at least one shoulder region of the garment 100 to form and connect a front bladder chamber portion located in a front portion of the garment 100 and a rear bladder chamber portion located in a back portion of the garment 100; (f) form and connect one or more sleeve portions and/or sleeve bladder portions of the garment 100, e.g., connected with a front garment portion (and its bladder chamber portion) and/or a rear garment portion (and its bladder chamber portion); and/or (g) form and connect a collar or hood garment portion and/or a collar or hood bladder portion of the garment 100, e.g., connected with a front garment portion (and its bladder chamber portion) and/or a rear garment portion (and its bladder chamber portion).

At the bonded regions 120 (e.g., the outer perimeter bonded regions 120 and/or interior bonded regions 120), the facing surfaces of the exterior laminated component 110A and the interior laminated component 110B are bonded together, e.g., by an adhesive bond or in an adhesive-free manner (e.g., by a melt bond, weld bond, or fused bond). Note FIGS. 1C and 1D.

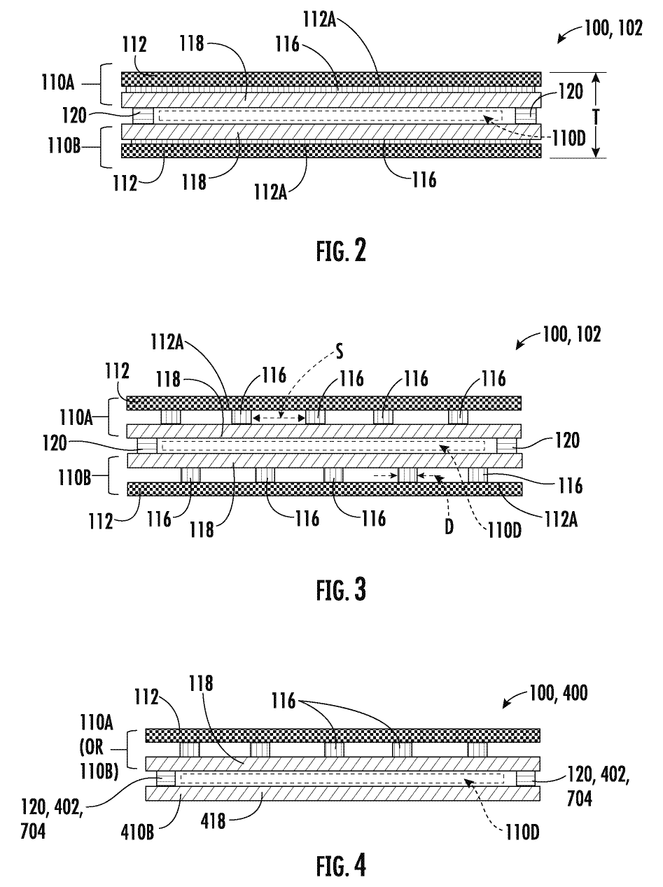

As some more specific examples, exterior laminated component 110A may be joined to interior laminated component 110B, e.g., by an adhesive provided between them at the bonded regions 120 (e.g., an adhesive bond bonding facing fabric surfaces, facing polyurethane or thermoplastic polyurethane film surfaces, other facing laminate component 110A, 110B surfaces, etc.) and/or by an adhesive-free bond (e.g., welded, melt bonded, and/or fuse bonded, for example, between facing surfaces of thermoplastic polyurethane film materials in the laminate components 110A, 110B). These interfacing surfaces are shown at reference number 114 in FIGS. 1C and 1D. In particular, the interfacing surfaces 114 may be surfaces of two film layers: (A) one comprised in the exterior laminated component 110A and the other comprised in the interior laminated component 110B, as will be described in more detail below in conjunction with FIGS. 2 and 3 or (B) one comprised in a laminated component 110A or 110B and the other comprised in a fluid impervious layer 410B, as will be described in more detail below in conjunction with FIGS. 4-10B.

At the inflatable chamber portions 110D, however, the facing surfaces of the exterior laminated component 110A and the interior laminated component 110B (or other fluid impervious layer 410B) are not bonded together such that an inflatable chamber portion 110D is defined between the facing surfaces. Note, for example, inflatable chamber portions 110D defined between surfaces 110AS and 110BS in FIGS. 1C and 1D.

FIG. 1A and 1B show bonded regions 120 at interior locations within the inflatable bladder chamber 110 of this specific example having a circular shape, with circles of substantially constant sizes arranged in staggered columns that extend from a top-to-bottom direction of the garment 100. In this illustrated example, the bonded regions 120 are evenly spaced throughout the overall garment structure 100. As shown in FIGS. 1A and 1B, the garment 100 of this example extends from a bottom opening 100B (e.g., waist opening) to a top opening 100N (e.g., neck opening) of the garment 100, and the bonded regions 120 are distributed (and may be substantially evenly distributed) around the garment 100 structure from the bottom opening 100B to the collar component 102C.

The bonded regions 120 may be provided in a wide variety of numbers, sizes, shapes, patterns, orientations, distributions, and the like, and may be present a wide variety of different aesthetic appearances. As some additional examples, the bonded regions 120 may be substantially round, square, rectangular, linear, curved, elongated, polygonal, oval, star shaped, cross shaped, or irregularly shaped in different specific examples of this technology.

In some specific examples of this technology, at least some of the individual interior bonded regions 120 may have a diameter or diagonal dimension of at least 5 mm (and in some examples, at least 6 mm or even at least 8 mm) and/or a continuous bonded area of at least 19.6 mm² (and in some examples, at least 28 mm² or even at least 50 mm²). At least 25% of the interior bonded regions 120 of a garment component 102 and/or an overall garment 100 structure may have sizes within the above ranges (and in some examples, at least 50%, at least 75%, or even at least 90% of the interior bonded regions 120 of a garment component 102 and/or an overall garment 100 structure may have sizes within the above ranges).

Further, a single garment 100 need not have all of the bonded regions 120 of the same number, size, shape, pattern, and/or orientation. The bonded regions 120 at interior locations within the bladder chamber 110 may be sized, shaped, and/or positioned to control a shape of the bladder chamber 110 (and thus a shape of the garment component 102) when it is in an inflated condition. A wide variety of bonded region 120 features are possible in various different specific examples of this technology.

FIGS. 1A and 1B show an example of a garment component 102 having an inflatable bladder chamber 110 engaged with another garment component. For example: (a) a garment component 102 that includes an inflatable bladder chamber 110 forming a front of the garment 100 may be engaged with a hood or collar member 102C that does or does not have an inflatable bladder chamber 110; (b) a garment component 102 that includes an inflatable bladder chamber 110 forming a rear of the garment 100 may be engaged with a hood or collar member 102C that does or does not have an inflatable bladder chamber 110; (c) a garment component 102 that includes an inflatable bladder chamber 110 forming a front of the garment 100 may be engaged with a side panel member that does or does not have an inflatable bladder chamber 110 (and, optionally, that same side panel member may be engaged with a rear garment component 102 that does or does not have an inflatable bladder chamber 110); (d) a garment component 102 that includes an inflatable bladder chamber 110 forming a rear of the garment 100 may be engaged with a side panel member that does or does not have an inflatable bladder chamber 110 (and, optionally, that same side panel member may be engaged with a front garment component 102 that does or does not have an inflatable bladder chamber 110); and/or (e) a garment component 102 that includes an inflatable bladder chamber 110 forming a sleeve of the garment 100 may be engaged with a panel member that does or does not have an inflatable bladder chamber 110, e.g., a panel member forming an interior region of the sleeve (and, optionally, that same panel member may be engaged with a rear garment component 102 that does or does not have an inflatable bladder chamber 110 and/or that same panel member may be engaged with a front garment component 102 that does or does not have an inflatable bladder chamber 110).

Such engagements specifically may be accomplished using a sewn seam 108, with the seam 108 stitching through the hood or collar member 102C, side panel, sleeve panel, and/or other garment component and through a portion of a bonded region 120 of garment component 102 (e.g., through a perimeter edge bonded region 120 of garment component 102). Additionally or alternatively, such engagements may be accomplished using one or more of adhesive bonding, adhesive-free bonding (e.g., formed by welding techniques, such as ultrasonic welding techniques and/or RF welding techniques), mechanical fasteners, etc.

As another example shown in FIGS. 1A and 1B, garment component 102 forming a front of the garment 100 may be engaged with another garment component that includes an inflatable bladder chamber 110, such as a garment component 102D forming a back portion of the garment 100.

Such engagements specifically may be accomplished using an adhesive bond or an adhesive-free bond (e.g., formed by welding techniques, such as ultrasonic welding techniques and/or RF welding techniques) between the garment components 102, 102D (e.g., by bonding their outer perimeter bonded regions 120 together, e.g., at shoulder seams as shown at reference number 108A in FIG. 1B and/or side seams). Additionally or alternatively, such engagements may be accomplished using one or more of a sewn seam, one or more mechanical fasteners, etc.

Additional examples and features of attaching two garment components (e.g., 102, 102D) with inflatable bladder chambers 110 are described in more detail, e.g., in U.S. Provisional Patent Appln. Nos. 63/677,693, 63/677,708, 63/677,842, 63/677,870, 63/726,392, 63/726,394, 63/726,399, and 63/726,427. FIGS. 1A and 1B further show that two garment components 102 and 102D having inflatable bladder chambers 110 may be engaged with an additional garment component (e.g., hood or collar member 102C, sleeve components 102, etc.). In this illustrated example, seam 108 extends to connect hood or collar member 102C with both the front garment component 102 and the back garment component 102D.

FIGS. 1A and 1D schematically show that this example garment 100 may include at least one pump component 130 for filling the inflatable bladder chamber 110 with air (or other desired gas). FIG. 1A shows the pump component 130 in broken lines because the pump component 130 may be located within a pocket 104 of the garment 100. The pump component 130 may be releasably attachable to fluid inlet port hardware that is fixed to one or more garment components 102 and opens into some portion of the bladder chamber 110.

If necessary or desired, an air intake 132 may be provided, e.g., defined through the pocket 104 (e.g., through garment component 102 and/or with the pump component 130), to provide air to be pumped or inserted into the inflatable bladder chamber 110.

Any desired type of pump component 130 may be provided, including a battery operated pump, a bulb type manual pump, a manually operated pump, etc. In some examples of this technology, a filter may be provided (e.g., at or with the air intake 132) to prevent dust, dirt, lint, or other undesired material from entering the pump component 130 (and thus the inflatable bladder chamber 110).

Additionally or alternatively, rather than (or in addition to) a pump 130, the garment 100’s inflatable bladder chamber 110 could be inflated by a blow tube, e.g., attached or attachable at the air intake 132 or other air input port.

FIGS. 1A and 1D also show that this example garment 100 may include at least one pressure release component 134, e.g., a pressure release valve, a closable opening (e.g., closed by a removable cap), etc., for releasing air (or other gas) from the inflatable bladder chamber 110. FIG. 1A shows the pressure release component 134 located at (e.g., within) a pocket 104 on the other side of the garment 100 from the pump component 130 (or other air input system).

If necessary or desired, at least one air outlet may be provided, e.g., defined through the pocket 104 (e.g., through garment component 102), but in some examples, the air released through the pressure release component 134 (e.g., through outlet 134O, see FIG. 1D) may be released to the interior of the pocket 104 or otherwise to the external environment.

As another example, the at least one pressure release component 134 may be provided on (e.g., mounted to) an interior layer of the garment 100 (e.g., through interior laminated component 110B), on (e.g., mounted to) an exterior layer of the garment 100 (e.g., through exterior laminated component 110A), and/or on (e.g., mounted to) layer 410B of FIG. 4.

Any desired type of pressure release component 134 may be provided, including a battery operated valve, a manually operated valve, an open outlet port covered by a removable cap, etc. The example of FIG. 1D shows a button 134A that may be pressed (against force applied by a spring 134S) to move a movable valve component (e.g., ball 134B) away from a fixed valve component (e.g., a valve seating area 134C) to open a fluid passageway through the fixed valve component to the fluid outlet 134O.

When the inflatable chamber portions 110D are inflated, the pressure of the gas within the inflatable chamber portions 110D pushes the movable valve component (e.g. ball 134B) against the fixed valve component (e.g., valve seating area 134C) to seal the pressure release valve and hold the gas within the inflatable chamber portions 110D.

Additionally or alternatively, one or more pressure release components 134 may include a valve-less pressure release structure in at least some example garment 100 structures. As a more specific example of such valve-less structures, the valve parts (e.g., valve 134B and valve seating area 134C) in one or more pressure release components 134 illustrated in FIG. 1D can be omitted and pressure release component 134 may comprise a cap that releasably secures to open and close a fluid outlet 134O, to thereby retain fluid within the bladder chamber 110 when closed and release fluid from the bladder chamber 110 when open.

Additionally or alternatively, if desired, the garment 100 may include one or more relief valves 136 at one or more locations around the garment 100 structure. The relief valves 136 may be activated to release pressure when and if pressure within the inflatable chamber portion(s) 110D exceeds a predetermined or predeterminable pressure value, e.g. becomes too high (e.g., above a “crack pressure” of the relief valve(s) 136).

Pressure may increase within the inflatable bladder portion(s) 110D at one or more local areas around the garment 100 or garment component 102, e.g., when external forces are applied to compress or flatten one or more inflatable chamber portions 110D and/or when external forces close off air access to some portion(s) of the inflatable bladder chamber 110.

For example, when a wearer sits down or falls down, some inflatable chamber portions 110D may become compressed and flattened, and the gas from those chamber portions 110D may flow into other chamber portions 110D and/or to other areas of the same chamber portion 110D. This movement of air increases the pressure of the inflatable chamber portions 110D particularly at some local areas (and may cause a significant pressure spike). One or more relief valve(s) 136 can operate to automatically open if the local pressure exceeds a predetermined or predeterminable threshold. Such relief valve(s) 136, when present, may help prevent separation of one or more interior bonded regions 120, may help prevent rupture of one or more of the inflatable chamber portions(s) 110D, and/or may help prevent breakage (e.g., bursting) of seams or seals, etc., and thereby increase the durability and life of the garment 100.

Any desired type of relief valve 136 may be provided. The example of FIG. 1D shows a relief valve 136 that includes a movable valve component (e.g., ball 136B) that is biased to seat against a fixed valve component (e.g., a valve seating area 136C) by a spring or other biasing member 136S. When fluid pressure in the local inflatable chamber portion 110D particularly exceeds the force applied to the movable valve component (e.g., ball 136B) by the biasing member 136S, the movable valve component (e.g., ball 136B) (e.g., ball 136B) moves away from the fixed valve component (e.g., valve seating area 136C) to open a fluid pathway through the relief valve 136 to the exterior environment (e.g., through valve outlet 136O).

Once the excess pressure within the local chamber portion 110D is sufficiently relieved (and/or the pressure spike has sufficiently abated), the biasing member 136S will force the movable valve component (e.g., ball 136B) back against the fixed valve component (e.g., valve seating area 136C) to again seal the relief valve 136 (and the inflatable chamber portion 110D).

FIGS. 1A, 1E, and 1F illustrate additional example features of garments 100 in accordance with at least some aspects of this technology. FIGS. 1E and 1F schematically show two garment components—e.g., a front left garment component 102L and a front right garment component 102R.

The garment components 102L and 102R particularly may have inflatable bladder chambers 110, e.g., corresponding to any of the garment components described herein, including bonded regions 120 selectively located to form (i) an outer perimeter seam 150A and (ii) one or more internal fixed regions 150B that define bladder chamber portions 110D.

In some examples of this technology, the bladder chamber portions 110D on the front left side garment component 102L may be in fluid communication with the bladder chamber portions 110D on the front right side garment component 102R, e.g., via fluid passageways 152 defined by or through the bonded regions 120 at the perimeter seam 150A. The fluid passageways 152 may connect with an inflatable bladder chamber portion 110D in a rear garment component (e.g., 102D in FIG. 1B). As another option, a fluid line may be provided to connect the fluid passageways 152 shown in FIGS. 1E and 1F (e.g., a fluid line may extend around a back component or back portion of the overall garment 100 structure). This fluid communication is shown schematically and generally in FIGS. 1E and 1F by arrow 154.

In the example of FIG. 1A, the garment 100 particularly includes a securing system 140 or a connector system, such as a zipper or other slider type fastening system. FIGS. 1E and 1F schematically illustrate some examples of manners in which securing systems 140 may be engaged with a garment 100 in accordance with aspects of this technology.

For example, as shown in FIG. 1E, this example securing system 140 includes: (a) one portion 156A engaged with or otherwise provided with the perimeter seam 150A at one edge of garment component 102L, and (b) another portion 156B engaged with or otherwise provided with an adjacent perimeter seam 150A of garment component 102R.

In some examples, each of securing system portions 156A and 156B may constitute portions of a zipper fastener or other slider fastener component. The portions 156A and 156B of securing system 140 particularly may be provided as or on strips of material (e.g., fabric) that can be attached to the garment components 102L and/or 102R by a sewn seam (e.g., through perimeter seam 150A), by an adhesive, by an adhesive free seam (e.g., a welded seam), and/or by one or more mechanical fasteners (e.g., one or more rivets or other couplings extending through perimeter seam 150A).

FIG. 1F is a view similar to FIG. 1E, but a different securing system 140 structure and engagement are shown. In the example of FIG. 1F, at least some portions of the securing system 140 may be directly formed in or provided on the garment component(s) 102L and/or 102R.

The specific example of FIG. 1F includes a button type securing system 140 in which one or more button holes 158A are formed (e.g., as through hole openings) directly through the perimeter seam 150A of one garment component (garment component 102L in this example) and one or more corresponding buttons 158B are fixed (e.g., by one or more of sewing, mechanical fasteners, adhesives, etc.) directly to the perimeter seam 150A of the other garment component (garment component 102R in this example). The one or more buttons 158B are shown in broken lines in FIG. 1F because they may be located on the other side of the surface shown in FIG. 1F. Alternatively, if desired, either the button hole(s) 158A and/or the button(s) 158B may be included with another component (e.g., such as mounted on a strip of material) that can be attached to garment component(s) 102L and/or 102R at perimeter seam 150A.

Other types of securing systems 140 may be used and attached to garments 100 and garment components 102 in manners similar to those shown in FIGS. 1E and/or 1F in other specific examples of this technology.

As some additional examples, the securing system 140 may include: (i) one or more snap type fasteners (e.g., with the snap components engaged with a flap of material attached to perimeter seam 150A or with snap components directly fixed with perimeter seam 150A); (ii) one or more buckle type fasteners (e.g., with the buckle hardware engaged with a flap of material attached to perimeter seam 150A or with the buckle hardware directly fixed with perimeter seam 150A and with the buckle strap engaged with some portion of the garment 100 (such as one of garment components 102L and/or 102R)); and/or (iii) other types of fasteners; etc.

Additionally or alternatively, the securing system 140 may comprise a belt (e.g., extending through one or more belt loops provided with one or more of the garment components 102L, 102R, etc.).

FIGS. 2 and 3 show features of laminated components 110A, 110B, bladders (including inflatable bladder chambers 110D), garment components 102, complete garments 100, and manners of making them in accordance with at least some examples of this technology. As shown, one layer of laminated components 110A, 110B constitutes a fabric 112. In other words, each one of laminated components 110A and 110B in the examples of FIGS. 2 and 3 comprises a respective fabric layer 112.

Various different types of fabrics 112 may be used in different examples of this technology. As some specific examples, fabric 112 may be an ethylene polyester (PET) material, another polyester material, a recycled polyester material, or a nylon material.

Additionally or alternatively, fabric 112 may be at least one of a layer of a knit textile, a layer of woven textile, and a layer of nonwoven textile. Still additionally or alternatively, in some specific examples, the fabric 112 may have a knit structure formed from a drawn textured yarn or a fully drawn yarn, (e.g., including a double jersey knit structure). In other examples, the fabric 112 may include a woven structure formed from a drawn textured yarn or a fully drawn yarn. Exemplarily, the fabric 112 may be a knit fabric formed from a drawn textured yarn and including a double jersey knit structure.

Additionally or alternatively, in some specific garment component 102 and/or garment 100 examples, the fabric 112 in a laminated component 110A and/or 110B may have: (a) a basis weight of at least about 15 grams per square meter (“gsm”) and less than about 150 grams per square meter; and/or (b) a linear mass density of at least about 10 denier and less than about 100 denier. As other potential ranges, the basis weight of the fabric 112 may be within a range of about 20 gsm to about 120 gsm, within a range of about 30 gsm to about 110 gsm, and/or within a range of about 35 to about 100 gsm.

Additionally or alternatively, as other potential ranges, the linear mass density of the fabric 112 may be within a range of about 12 denier to about 90 denier, within a range of about 15 denier to about 80 denier, and/or within a range of about 20 denier to about 70 denier. Still additionally or alternatively, the fabric 112 may comprise a monofilament or multi-filament polyester.

The fabric 112 may have a durable water repellant (“DWR”) (or water resistant) coating at least partly applied to it (especially any fabric 112 layer that may be exposed at the exterior of a garment 100 in a final garment 100 structure). Such a coating may be applied before the lamination process is used to apply the film 118 to the fabric 112, or the DWR coating may be applied at a later time (after lamination).

Further, the DWR material may be at least partly applied to just one surface of the fabric 112 or to both surfaces, and/or the two opposite surfaces of a fabric 112 component need not have the same amount of DWR material applied to it. The DWR material may be applied by dipping, spraying, printing, coating, and/or in other desired manners. Suitable DWR materials for fabrics are conventionally known and commercially available (e.g., fluoropolymer based materials).

For the structure shown in FIG. 2, an adhesive 116 is applied to at least some portion of a surface 112A of the fabric 112. Any desired manner of applying the adhesive 116 may be used, including spray, coating, printing, painting, etc. Also, any desired type of adhesive 116 may be used. In the example of FIG. 2, the adhesive 116 is applied as a “full” layer on the surface 112A of the fabric 112. In the “full” layer examples, the adhesive 116 layer may have a constant thickness or a varying thickness.

After the adhesive 116 is applied, a film 118 is applied to the adhesive 116 side of the adhesive infused fabric to form a laminated component, e.g., laminated component 110A and/or 110B. In the illustrated example of FIG. 2, the adhesive 116 is a “full layer” (e.g., of constant or varying thickness) covering at least 90% (and up to 100%) of the surface area between the fabric 112 and the film 118. The term “substantially continuously” (and variations thereof) as used herein in this context means that adhesive 116 is applied between a fabric 112 and a film 118 to cover at least 90% (and up to 100%) of a surface area between facing and connected surfaces of the fabric 112 and the film 118.

As described above in conjunction with FIG. 2, in some examples of this technology, the laminated components 110A and 110B are formed with a full layer of adhesive 116 (or a substantially continuous layer of adhesive 116) joining fabric 112 to film 118. In some examples of this technology, however, a full layer of adhesive 116 will not be used to form laminated components 110A and/or 110B.

FIG. 3 illustrates a fabric 112 component having adhesive 116 applied to a surface 112A thereof “discontinuously” or “intermittently,” e.g., as a plurality of spaced-apart adhesive regions disposed throughout the fabric surface 112A. The spaced-apart adhesive 116 regions may be applied to the surface 112A of the fabric 112 (or to the film 118) in any desired manner, such as by printing, by application of two-sided tape to the surface 112A or film 118, etc.

When present “intermittently” or “discontinuously,” the adhesive 116 covers less than 90% of the surface area between the fabric 112 and the film 118. In some examples of this technology, the adhesive 116 may be applied intermittently, in spaced-apart adhesive 116 regions, to cover less than 85% of an interfacing surface area between the film 118 and the fabric 112, and in some examples, less than 75%, less than 60%, less than 50%, less than 40%, or even less than 25% of this interfacing surface area. The distribution of adhesive 116 between the fabric 112 and film 118 (e.g., size, shape, and/or density of spaced-apart adhesive 116 regions) may be constant throughout the overall interfacing surface area of a laminated component 110A, 110B, or it may be varied at different regions of the overall interfacing surface area of a laminated component 110A, 110B. The “spaced-apart” adhesive 116 features can help provide a softer feel and improved drape for laminated components 110A, 110B formed from the fabric 112, adhesive 116, film 118 laminates (e.g., due to gaps between the adhesive 116 regions allowing more flexibility and producing less stiffness).

In some examples, the adhesive 116 regions will take the form of adhesive “dots,” e.g., substantially of round, oval, square, polygonal, or other desired shape(s). At least some of the spaced-apart adhesive 116 regions (or dots) may have a largest diagonal or diameter dimension D such that the spaced-apart adhesive 116 regions (e.g., dots) will be sized and shaped to contact at least 2 consecutive loops of a knit structure forming fabric 112 (and in some examples, at least 3 consecutive loops or even at least 5 consecutive loops), but particularly fewer than 10 consecutive loops of the knit structure forming fabric 112.

Specifically, the use of a drawn textured yarn with spaced-apart adhesive 116 regions of these size ranges may help the adhesive flow or sink into the knit structure to provide strong bonding and good peel strength (resistance to peeling or delamination).

Additionally or alternatively, the spaced-apart adhesive 116 regions (or dots) may be spaced from immediately adjacent neighboring adhesive 116 regions (or dots) by a spacing dimension S. Dimension D and dimension S in a specific laminated component 110A and/or 110B may be selected and balanced with respect to one another to provide a desired degree of drape or handfeel while still providing adequate peel strength. For example, smaller-sized adhesive 116 dots size (e.g., D) and/or greater adhesive 116 dot spacing (e.g., S) will tend to produce laminated components 110A, 110B having better drape and handfeel properties (as the lower amounts of adhesive 116 may tend to make the laminated component 110A, 110B feel softer and more like the base fabric 112), but the lower amount of adhesive 116 may adversely impact peel strength (and make the laminated component(s) 110A, 110B more susceptible to delamination). On the other hand, larger adhesive 116 sized dots (e.g., D) and/or smaller adhesive 116 dot spacing (e.g., S) will tend to produce laminated components 110A, 110B having excellent peel strength (and less susceptibility to delamination), but the laminated components 110A, 110B may tend to feel stiffer and have less favorable drape and handfeel properties.

The diameter or diagonal dimension D, the adhesive 116 region size ranges with respect to the number of consecutive loops, and/or the adhesive 116 region spacing dimension S described above may be present (or, in other words, apply) for at least about 25% of the spaced-apart regions of adhesive 116 in a garment 100 or garment component 102 structure, and in some examples, these ranges particularly may be present or apply for at least about 40%, at least about 50%, at least about 75%, at least about 80%, or even at least about 90% of the spaced-apart regions of adhesive 116 in a garment 100 or garment component 102 structure.

Whether using a full adhesive 116 layer (e.g., FIG. 2) or spaced-apart adhesive 116 regions (e.g., FIG. 3) between the fabric 112 and film 118 layers, laminated components 110A and/or 110B in accordance with examples of this technology may be constructed to have desired drape and/or handfeel properties. In addition to adhesive 116 dot size and/or spacings, other garment structural features particularly can impact the drape and handfeel properties, such as adhesive 116 layer thickness (e.g., for full glue examples), adhesive 116 material, fabric 112 materials, fabric 112 thickness, film 118 thickness, number of layers in the film 118, etc. As some more specific examples of this technology, a laminated component 110A and/or 110B may have drape properties that are comparable to the drape properties of the fabric 112 layer when present alone (e.g., within a threshold amount of the drape properties of the fabric 112 when present alone).

In some examples of this technology, the laminated components 110A, 110B will have a peel strength between the fabric 112 and the film 118 layer of at least about 0.85 kg/cm, and in some examples, at least about 0.9 kg/cm, at least about 0.95 kg/cm, at least about 1 kg/cm, or even at least about 1.05 kg/cm. Peel strength may be measured using International Standard ISO 2411.

FIG. 3 provides a partial cross-sectional view of a garment 100 or garment component 102 similar to the view of FIG. 2 but with an intermittent adhesive 116 layer connecting the fabric 112 and film 118 layers in both the exterior laminated component 110A and the interior laminated component 110B. The garments 100 or garment components 102 shown in FIG. 3 may be made in the same general manners as described above in conjunction with FIG. 2. Use of an intermittent adhesive 116 layer between the fabric 112 and film 118—as shown in FIG. 3—may help improve the softness, hand feel, and/or drape features of garments 100 and garment components 102 in accordance with some aspects of this technology (e.g., because less adhesive 116 is present to stiffen the laminate).

Once the laminated components 110A and 110B are formed, they may be bonded together to form garment components 102 and/or garments 100 that have fluid impervious interior bladder chambers 110D. More specifically, exterior laminated component 110A may be bonded to interior laminated component 110B using an adhesive or in an adhesive-free manner. For example, exterior laminated component 110A and interior laminated component 110B may be placed in a press so that their film 118 layers directly face one another. If needed, an adhesive may be applied between exposed and interfacing surfaces of the films 118 (e.g., to the surface of the film 118 on either or both of laminate components 110A, 110B) in a pattern to form the desired bonded regions 120 (e.g., to form an outer perimeter seam 150A and any desired interior bonded regions 120, 150B).

Additionally or alternatively, the press (e.g., its press plates) may include tooling to selectively apply force (pressure and/or heat) only at the desired bonded region 120 locations (e.g., to form an outer perimeter seam 150A and any desired interior bonded regions 120, 150B).

Then, the laminated components 110A and 110B are pressed together in the press, optionally with heating, to selectively bond the film 118 layers of the laminated components 110A and 110B together, e.g., at locations where adhesive is present and/or in an adhesive-free manner, to form the bonded regions 120 of a garment component 102 and/or garment 100. For adhesive-free bonded regions 120, the pressing force (and optionally heating, if needed) may be applied using welding techniques (e.g., RF welding, ultrasonic welding, high-frequency welding, laser welding, impulse welding, etc.); using heat sealing techniques; and/or using melt bonding techniques.

The bonded regions 120 and garment components 102 of FIGS. 2 and/or 3 may be formed in any of the ways described in any of U.S. Patent Appln. Nos. 63/677,693, 63/677,708, 63/677,842, 63/677,870, 63/726,392, 63/726,394, 63/726,399, and/or 63/726,427.

During pressing steps to form the garment components 102 of FIG. 3, the exterior laminated component 110A particularly may be exposed to somewhat different heating and/or pressing conditions than the interior laminated component 110B, e.g., depending on the starting temperature, the dwell time under pressing conditions, and/or if just one press plate 400A or 400B is heated.

Differences in the pressing conditions particularly may cause the adhesive 116 in one laminated component 110A to soften (potentially melt and/or spread out) to somewhat a different degree than that of the other laminated component 110B. Thus, even if laminated components 110A, 110B have the same structures when the bladder and/or garment fabrication process starts, they may have somewhat different structures after heating and pressing occurs.

In some examples of this technology, intermittently applied regions of adhesive 116 may be provided between the film 118 and the fabric 112 in both the exterior laminated component 110A and the interior laminated component 110B. In such structures, the intermittently applied regions of adhesive 116 need not be applied in the same pattern in the exterior laminated component 110A as the pattern in the interior laminated component 110B. For example, the exterior laminated component 110A may have a different number, size, shape, spacing, density (e.g., regions per square meter), average size, average spacing, average dispersion density, and/or arrangement of spaced-apart regions of adhesive 116 as compared to the number, size, shape, spacing, density, average size, average spacing, average dispersion density, and/or arrangement of spaced-apart regions of adhesive 116 of the interior laminated component 110B.

In particular, in some examples of this technology, the spaced-apart regions of adhesive 116 in the exterior laminated component 110A will not align with the spaced-apart regions of adhesive 116 in the interior laminated component 110B (e.g., in the vertical direction shown in FIG. 3), when the garment 100 or garment component 102 is supported on a horizontal base surface in a flat and unfolded orientation. In other words, the positions of the spaced-apart regions of adhesive 116 in the exterior laminated component 110A need not mirror the positions of the spaced-apart regions of adhesive 116 in the interior laminated component 110B.

Asymmetries between the spaced-apart regions of adhesive 116 in the exterior laminated component 110A as compared to the interior laminated component 110B particularly may help improve the hand feel and/or drape properties by potentially providing less adhesive 116 material in a direct straight line direction from the exterior-most surface to the interior-most surface of the garment component 102 (e.g., allowing the laminated components 110A, 110B to flex more easily based on the flex properties of the fabric 112 layers).

The step of fixing the film 118 to the fabric 112 (via adhesive 116) to form the laminated components 110A, 110B of FIGS. 2 and 3 specifically can take place in any desired manner, including via conventional lamination techniques, via extrusion techniques, etc. The film 118 layer (e.g., a thermoplastic elastomer layer, such as a thermoplastic polyurethane layer or a polyurethane layer) may be directly extruded onto the fabric 112.

The film 118 may be made of any desired type of material that is capable of forming fluid impervious surfaces of an inflatable bladder chamber 110. In some more specific examples of this technology, the film 118 may comprise a layer chosen from at least one of: (i) a layer of a thermoplastic polyurethane material and (ii) a layer of a polyurethane material. Additionally or alternatively, in some specific examples, the film 118 may have a multi-layered structure, e.g., with one or more layers of thermoplastic polyurethane material and/or with one or more layers of polyurethane material.

In some examples of this technology, overall film 118 (e.g., the composite of all film 118 layers present) will be less than about 150 micron thick, and in some examples, less than about 120 micron thick, less than about 100 micron thick, less than about 80 micron thick, less than about 70 micron thick, less than about 60 micron thick, or even less than about 50 micron thick. As some additional examples, film 118 may be at least about 25 micron thick (with the upper end of the range being within any of the ranges described above).

The structure depicted in FIG. 2 shows the laminated component 110A, 110B particularly formed from a film 118 that constitutes a single layer. In other examples, however, the film 118 itself may have a multi-layered construction.

As one particular example, one film 118 layer may comprise a thermoplastic polyurethane layer and the other layer of the film 118 may comprise a polyurethane layer. These two layers may be joined together (e.g., by an adhesive, by a lamination technique, by co-extrusion, by blowing techniques, etc.) to form film 118 as a composite film layer (e.g., a multi-layered film made from two materials and/or two layers).

When formed as a multi-layered film 118 including a thermoplastic polyurethane layer and a polyurethane layer, the thermoplastic polyurethane layer may face inwardly (e.g., and form the interior surface of inflatable bladder chamber 110D) and the polyurethane layer may directly face (and contact) the fabric layer 112.

As another particular example of a multi-layered film 118 structure, one layer of film 118 may comprise a thermoplastic polyurethane layer having a first melt temperature or melting point and the other layer may comprise a thermoplastic polyurethane layer having a second melt temperature or melting point, wherein the second melt temperature or melting point is higher than the first melt temperature or melting point (e.g., at least 10 degrees C higher, and in some examples, at least 20 degrees C higher, or even at least 30 degrees C higher). These two layers TPU layers with different melting points may be joined together (e.g., by an adhesive, by a lamination technique, by co-extrusion, by blowing techniques, etc.) to form film 118 as a composite film layer or a multi-layer film. In such structures, the TPU layer having the higher melt temperature may be directly engaged with the fabric 112 layer and the TPU layer having the lower melt temperature may remain exposed (to form the interior surface of inflatable bladder chamber 110D). Thus, the TPU layer having the lower melt temperature may form the interior surface of a bladder chamber 110 and will be available for forming bonded regions 120 when the final garment component 102 including an inflatable bladder chamber 110D is formed.

Separating a TPU layer having a lower melt temperature from the fabric 112 with a TPU layer having a higher melt temperature may enable use of somewhat lower processing temperatures when making the bonded regions 120 of garment component 102 (e.g., when applying heat and pressure and/or when applying welding conditions (e.g., RF welding, etc.) discussed above). In at least some examples of such processing steps, the TPU layer having the higher melt temperature may maintain a stable bond to the fabric 112 while the TPU layer having the lower melt temperature bonds to a facing layer of TPU material to form the bonded region(s) 120 (e.g., perimeter seam 150A and interior bonded regions 150B).

In film 118 structures of the types shown in FIGS. 2 (and 3), the overall film 118 (e.g., the single film layer 118 or the sum of multiple layers forming a film 118) will be less than about 150 micron thick, and in some examples, less than about 120 micron thick, less than about 100 micron thick, less than about 80 micron thick, less than about 70 micron thick, less than 60 micron thick, or even less than 50 micron thick. As some additional examples, film 118 (e.g., the single film layer 118 or the sum of multiple layers forming a film 118) may be at least about 25 micron thick or even at least about 30 micron thick (with the upper end of the range being within any of the ranges described above).

In multi-layer film 118 examples, each individual film layer: (a) may be at least about 10 micron thick or even at least about 20 micron thick and less than about 100 micron thick, and in some examples, less than about 75 micron thick, less than about 60 micron thick, less than about 50 micron thick, less than about 40 micron thick, less than about 35 micron thick, less than about 30 micron thick, or even less than about 25 micron thick.

When two (or more) film layers are present in a multi-layered film 118, the individual film layers may have the same or different thicknesses (e.g., within the ranges described above). As one specific example, a two-layered film 118 of this type may have: (i) a thermoplastic polyurethane layer having a thickness of about 25 micron and (ii) a polyurethane layer or a higher melt temperature thermoplastic polyurethane layer having a thickness of about 25 micron or less. These thickness measurements may comprise thicknesses measured before lamination of film 118 to a fabric 112 layer. Lamination to the fabric 112 may result in a “compressed” or reduced thickness of the film 118 layer. In some specific examples, an initial about 50 micron film 118 layer thickness prior to lamination to fabric 112 may be compressed or reduced to a thickness of about 32 micron (total film 118 thickness) after lamination and engagement with the fabric 112.

Film 118 “compression” of this type may occur with single layer films (e.g., as shown in FIG. 2 and 3) and/or multi-layer films 118. As some specific examples, the film 118 thickness differential prior to lamination with fabric 112 v. after lamination with fabric 112 may be at least 10% smaller, and in some examples, at least 15% smaller, at least 20% smaller, at least 25% smaller, or even at least 30% smaller.

FIG. 4 illustrates a garment component 400 (which could constitute a complete garment 100) in accordance with other examples of this technology. Where the same reference number is used in FIG. 4 as used in any of FIGS. 1A-3 discussed above, the same or similar parts are being referenced, and much of the overlapping or duplicative description may be omitted.

In the example of FIG. 4, the garment component 400 includes an exterior laminated component 110A layer or an interior laminated component 110B layer that may have any of the features described above in conjunction with FIGS. 2 and 3.

An inflatable bladder chamber portion 110D (or even a complete bladder chamber 110) may be formed between: (i) the film 118 layer of the exterior laminated component 110A and (ii) a layer 410B of the garment component 400 that directly faces the film 118 layer of the exterior laminated component 110A. In this illustrated example, the layer 410B may include a film or sheet 418 having: at least one polyurethane layer and/or at least one thermoplastic polyurethane layer.

Film 418 may correspond to and/or have any of the features of films 118 described above. Alternatively, film 418 may be made somewhat thicker than the thicknesses for layer 118 described above, e.g., if necessary to provide adequate strength and durability. In some examples of this technology, layer 410B will be formed just by the film 418.

In some examples of this aspect of the present technology, the film 418 will remain exposed and will constitute an exposed surface (e.g. an interior-most layer) of the garment component 400 (and optionally an exposed surface of a garment 100 including that garment component 400). In such structures, the film 418 may be formed from a transparent, partially transparent, or translucent material, e.g., permitting visual access to at least some portions of the interior of the bladder chamber portion(s) 110D.

Additionally, while the discussion of FIG. 4 above describes film 418 as being located at the interior of the garment 100 (and the garment 100’s interior-most layer), in other examples of this technology, if desired, the film 418 may constitute an outer exterior-most surface or layer of the garment 100, and the component identified as exterior laminated component 110A in FIG. 4 may be replaced by interior laminated component 110B.

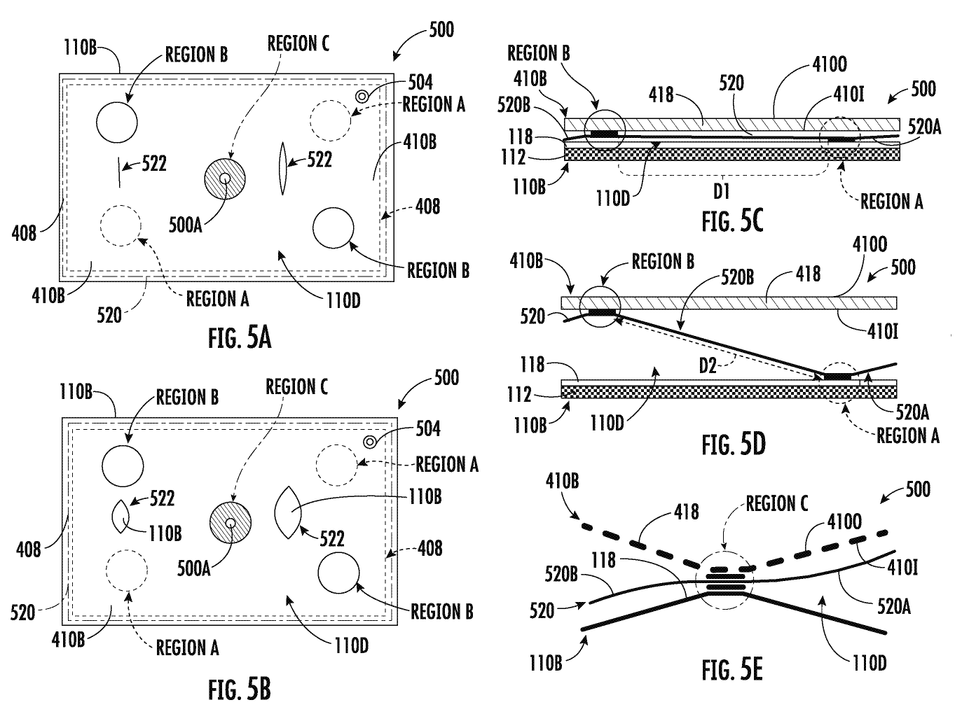

Use of a transparent, partially transparent (e.g., a colored transparent film, such as a film that is transparent to some visible light wavelengths but not all), semitransparent, or a translucent material as film 418 in the example structure of FIG. 4 provides opportunities for producing interesting designs and/or aesthetics. As some examples, adhesives 402 (forming bonded regions 120) and/or 116 may be visible through film 418. Thus, these adhesives 402 and/or 116 may be applied in different colors and/or interesting patterns that can be viewed through film 418. Additionally or alternatively, features may be provided within the bladder chamber portion 110D (e.g., provided on or with the laminated component 110A and/or 110B) that may be seen through film 418). Still additionally or alternatively, the films 418 themselves (e.g., including portions thereof) may be in different colors, e.g., to provide additional features for aesthetic designs. Additional examples of such features will be described below in conjunction with FIGS. 5A-5E.

FIGS. 5A-5E provide various views of features and examples of garment components 500 in accordance with some examples of this technology. FIG. 5A shows a plan view illustrating features of an inflatable garment component 500 in a deflated configuration; FIG. 5B shows a similar plan view illustrating features of an inflatable garment component 500 in an inflated configuration; FIG. 5C provides a partial cross sectional view of an inflatable garment component 500 in a deflated configuration; FIG. 5D provides a partial cross sectional view of an inflatable garment component 500 in an inflated configuration; and FIG. 5E provides a partial cross sectional view of another area of an inflatable garment component 500 in an inflated configuration. While FIGS. 5A and 5B illustrate a relatively small garment component 500 swatch, the structures included in the garment component 500 examples of FIGS. 5A-5E may be formed as an entire garment component (e.g., any of elements 102, 102D discussed above) or may be formed as an entire garment structure (e.g., element 100 discussed above). Where FIGS. 5A-5E use the same reference numbers as those used above, the same or similar parts are being referenced (with any of the features, alternatives, and/or options for those parts), and much of the overlapping description may be omitted.

The garment component 500 may include a laminate structure 110B, e.g., as an interior-most layer thereof. This laminate structure 110B may have any of the features described above in conjunction with FIGS. 2-4, including: (i) a fabric 112 (e.g., knit, woven, non-woven, etc.) having an inner face and an outer face, and (ii) a film 118 including at least one fluid impervious layer chosen from a polyurethane layer and a thermoplastic polyurethane layer. The film 118 is adhesively bonded to the inner face of the fabric 112 to form the laminate structure 110B, e.g., by a “full” layer of adhesive 116 (e.g., as shown in FIG. 2) or by intermittently applied adhesive 116 (e.g., as shown in FIG. 3).

In addition to the laminate structure 110B, the garment component 500 of FIGS. 5A-5E includes an exterior layer 410B that includes an interior surface (410I, see FIGS. 5C and 5D) and an opposite exterior surface (410O, see FIGS. 5C and 5D). The exterior layer 410B is fixed with respect to the laminate structure 110B to form a fluid impervious chamber 110D between (i) the film 118 of the laminate structure 110B and (ii) the interior surface 410I of the exterior layer 410B. In these illustrated examples, the exterior layer 410B is formed from a transparent, partially transparent (semi-transparent), or translucent material (e.g., a TPU material). Thus, the exterior layer 410B is not readily apparent in the views of FIGS. 5A-5B, but it is shown in FIGS. 5C-5E.

The garment component 500 of FIGS. 5A-5E also includes a sheet member 520 located within the fluid impervious chamber 110D. The sheet member 520 perimeter is shown as a dot-dash line in FIGS. 5A and 5B. The sheet member 520 may be considered a single layer “tether member” as that term is used herein. The sheet member 520 may be fixed, e.g., around at least one or more portions of its perimeter edges, together with seam 408 (e.g., adhesive or other bonds) that fixes interior layer 110B with the exterior layer 410B to form the fluid impervious chamber 110D. The inner edge of the seam 408 is shown by broken lines in FIGS. 5A and 5B, and this inner edge forms an outer perimeter of the fluid impervious chamber 110D. The garment component 500 may include one or more inflation ports 504.

As shown in FIG. 5C, the sheet member 520 of this example includes: (i) a first major surface 520A and (ii) a second major surface 520B located opposite the first major surface 520A. At one or more regions of the sheet member 520, the first major surface 520A is bonded to the film 118 of the interior layer 110B and the opposing second major surface 520B at those regions is unbonded to the interior surface 410I of the exterior layer 410B. Examples of these areas are identified as Region A in FIGS. 5A-5D. The Region A bonds may be formed by adhesives and/or in an adhesive-free manner. The Region A bonds may be considered “first side bonded regions,” as that term is used herein.

Additionally or alternatively, at one or more other regions of the sheet member 520, the second major surface 520B of the sheet member 520 is bonded to the interior surface 410I of the exterior layer 410B and the opposing first major surface 520A at those regions of the sheet member 520 is unbonded to the first film 118. Examples of these areas are identified as Region B in FIGS. 5A-5D. The Region B bonds may be formed by adhesives and/or in an adhesive-free manner. The Region B bonds may be considered “second side bonded regions,” as that term is used herein.

Additionally or alternatively, at one or more other regions of the sheet member 520: (i) the first major surface 520A of the sheet member 520 is bonded to the film 118 of the interior layer 110B and (ii) the second major surface 520B of the sheet member 520 is bonded to the interior surface 410I of the exterior layer 410B. Examples of these areas are identified as Region C in FIGS. 5A, 5B, and 5E. The Region C bonds may be formed by adhesives and/or in an adhesive-free manner. Region C bonds of this type also may be used to attach other components to garment component 500, such as areas for mounting a pocket component, areas for mounting hardware components, other desired seam areas, etc. Regions where all layers are bonded together, like Region C, also are referred to herein as “complete bonded regions.”

In some examples of this technology, one or more through hole openings that extend completely through the garment component 500 may be formed at the Region C bonds or the complete bonded regions. An example through hole opening is shown at element 500A in FIGS. 5A and 5B. In these structures, the through hole openings 500A extend completely through each of interior laminate component 110B, the exterior layer 410B, and the sheet member 520 (from its first major surface 520A to its second major surface 520B). Such openings 500A may provide openings for breathability, for ventilation, for mounting other components, etc.

The garment components 500 of FIGS. 5A-5E further include expanse regions of the sheet member 520 that extend between the bonds of bonded Regions A, B, and C. In such expanse regions, the sheet member 520 remains unfixed and is free to extend in any manner and/or in any direction that is supported between the various bonded regions. Thus, the sheet member 520 may extend between and span the distance between the film 118 of the interior layer 110B and the interior surface 410I of the exterior layer 410B one or more times, even when the garment component 500 is in the inflated configuration.

The numbers, locations, sizes, shapes, and/or relative positioning of the bonded areas corresponding to Regions A, B, and/or C may be selected to control the shape and/or thickness of the garment component 500 when in the inflated configuration. Additionally or alternatively, the numbers, locations, sizes, shapes, and/or relative positioning of the bonded areas corresponding to Regions A, B, and/or C may be selected to produce desired design and/or graphical features for the garment component 500 in the deflated configuration and/or in the inflated configuration.

As further shown in FIG. 5C, in the deflated configuration, bonded Region A is separated from bonded Region B by a distance D1. In the inflated configuration shown in FIG. 5D, bonded Region A is separated from bonded Region B by a distance D2. Distance D2 (in the inflated configuration) may be greater than distance D1 (in the deflated configuration). The difference between D1 and D2 may depend, at least in part, by the relative positioning of other bonded regions, such as Regions A, B, and/or C, the perimeter edge seam 408, the stretchability of sheet member 520, the presence and/or amount of slack in the sheet member 520 (if any), etc.

FIGS. 5A-5B further show that the sheet member 520 may include one or more through holes 522 (including one or more slits) extending completely through the sheet member 520, i.e., from the first major surface 520A to the second major surface 520B thereof. In some more specific examples, at least a portion of at least one of these through holes 522 may be located between a bond having the Region A structure and a bond having the region B structure. Thus, at least when the garment component 500 is changed to the inflated configuration, the through hole 522 may expand in size such that a portion of the interior surface (e.g., film 118 surface) of the interior laminate component 110B is visible through the exterior layer 410B (if it is transparent, partially transparent, or translucent) and through the sheet member 520. Compare the through holes 522 in FIGS. 5A and 5B. Expansion and contraction of the size of through hole(s) 522 also may result in changes between distances D1 and D2, discussed above.

These structural features of the garment component 500 (e.g., a transparent, partially transparent, or translucent exterior layer 410B, an intermediate sheet member 520, and through hole opening(s) 522) provide several structural and/or design options for garment components 500 and garment products. As some examples, garment components 500 can be designed such that different colors and/or graphics can be viewed when the garment component is changed between: (i) a deflated configuration (e.g., in which the through hole opening(s) 522 within the garment component 500 interior chamber 110D are smaller and/or more closed) and (ii) an inflated configuration (e.g., in which the through hole opening(s) 522 within the garment component 500 interior chamber 110D are larger, widened, and/or more open). These changes can be viewed through the transparent, partially transparent, or translucent exterior layer 410B. As some more specific examples, a color or graphic (e.g., located on laminate structure 110B) may be “revealed” as the garment component 500 inflates and the through hole openings 522 in the sheet member 520 open up, unfold, and/or widen. As another example, a color or graphic (e.g., located on major surface 520B of sheet member 520) may be “revealed” as the garment component 500 deflates and the through hole openings 522 in the sheet member 520 close down and/or fold together.

Thus, in some examples of this technology, when the interior surface (e.g., film 118 surface) of the interior laminate component 110B is colored differently from the sheet member 520 and/or includes a graphical element (e.g., a logo), that different color and/or graphical element may become more prominently displayed and more visible (e.g., “revealed”) through the transparent/translucent exterior layer 410B and through the “enlarged” through hole openings 522 of the sheet member 520 as the garment component 500 is inflated. These features can be used to change the color pattern and the visual appearance of the overall garment component 500 as the garment component 500 changes between the deflated configuration and the inflated configuration, e.g., so that this “reveal” occurs upon inflation.

Additionally or alternatively, when the major surface 520B of the sheet member 520 is colored differently from the interior surface of laminate component 110B and/or includes a graphical element (e.g., a logo), that different color and/or graphical element may become more prominently displayed and more apparent through the transparent/translucent exterior layer 410B as the through hole openings 522 of the sheet member 520 come together when the garment component 500 is deflated. These features can be used to change the color pattern and the visual appearance of the overall garment component 500 as the garment component 500 changes between the inflated configuration and the delated configuration, e.g., so that this “reveal” occurs upon deflation.

In the examples of FIGS. 5A-5E, the sheet member 520 is fluid permeable, e.g., so that the interior chamber 110D of the garment component 500 is in open fluid communication on opposite sides of the sheet member 520. This may be accomplished in many different ways. For example, the sheet member 520 may be made from a fabric or textile sheet material and/or other fluid permeable material. Additionally or alternatively, the through hole openings 522, when present, may provide a suitable level of fluid permeability across the sheet member 520 (e.g., if the sheet member 520 is otherwise fluid impervious).

The sheet member 520 may cover a wide range of the area of a garment component 500 in different examples of this technology. As some more specific examples, in garment components 500 in which the laminate structure 110B and the interior surface 410I of the exterior layer 410B are fixed with respect to one another at an outer perimeter seam 408: (i) the outer perimeter seam 408 will define an area A1 of the fluid impervious chamber 110D, (ii) an outer perimeter edge of the sheet member 520 will define an area A2 of the sheet member 520, and (iii) the area A2 will be at least 25% of the area A1 (at least 0.25 × A1), and in some examples, A2 will be at least 0.4 × A1, at least 0.5 × A1, at least 0.6 × A1, at least 0.75 × A1, at least 0.9 × A1, or even at least 0.95 × A1. Additionally or alternatively, in some examples, all of the laminate structure 110B, the interior surface 410I of the exterior layer 410B, and at least a portion of an outer perimeter edge of the sheet member 520 (including up to 100% of the outer perimeter edge of the sheet member 520) will be fixed with respect to one another at the outer perimeter seam 408 of the garment component 500.

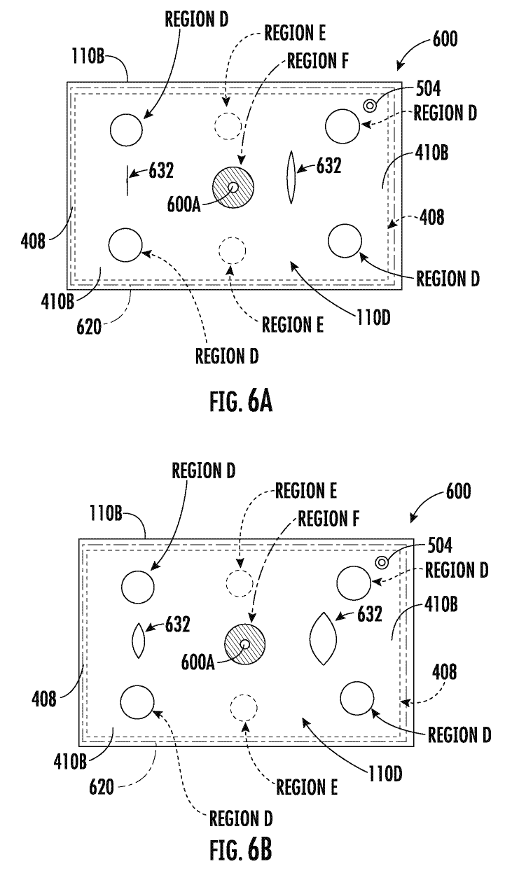

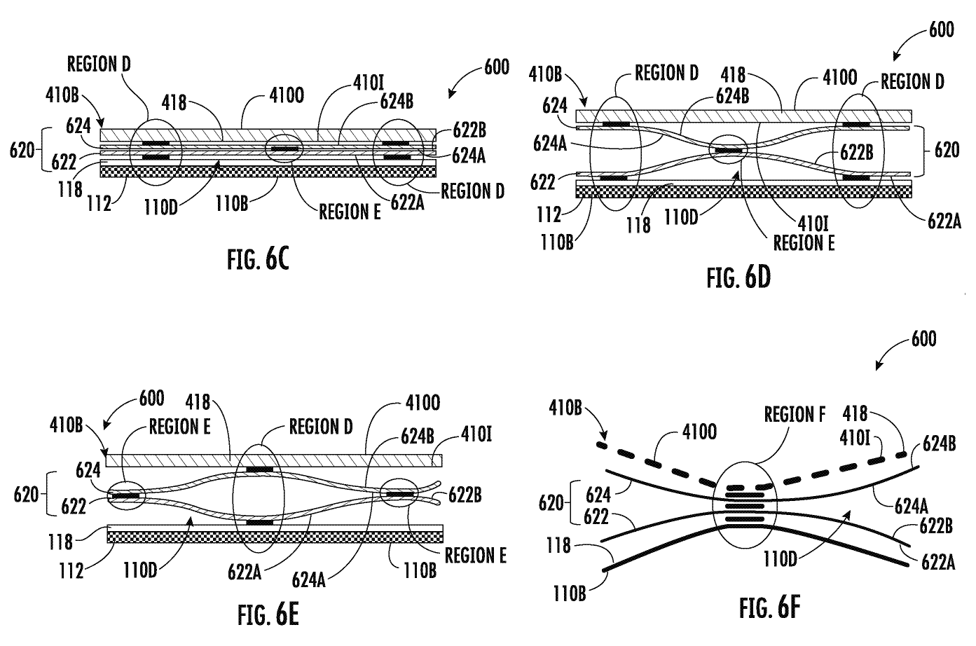

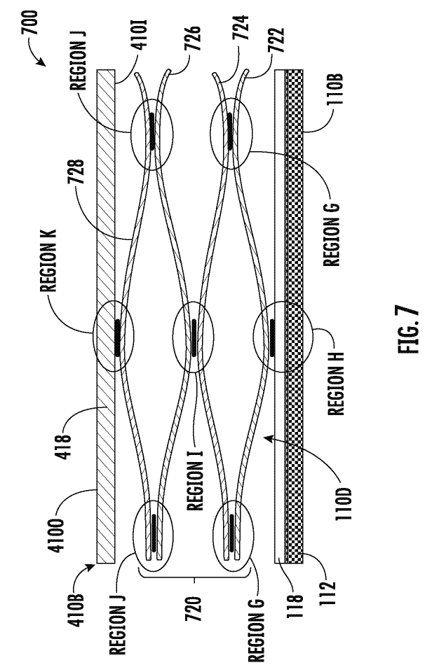

FIGS. 6A-6F provide various views of features and examples of additional garment components 600 in accordance with some examples of this technology. FIG. 6A shows a plan view illustrating features of an inflatable garment component 600 in a deflated configuration; FIG. 6B shows a similar plan view illustrating features of an inflatable garment component 600 in an inflated configuration; FIG. 6C provides a partial cross sectional view of an inflatable garment component 600 in a deflated configuration; FIGS. 6D-6F provide partial cross sectional views of an inflatable garment component 600 in an inflated configuration at various different areas of the garment component 600. While FIGS. 6A and 6B illustrate a relatively small garment component 600 swatch, the structures included in the garment component 600 examples of FIGS. 6A-6F may be formed as an entire garment component (e.g., any of elements 102, 102D discussed above) or may be formed as an entire garment structure (e.g., element 100 discussed above). Where FIGS. 6A-6F use the same reference numbers as those used above, the same or similar parts are being referenced (with any of the features, alternatives, and/or options for those parts), and much of the overlapping description may be omitted.

The garment component 600 may include a laminate structure 110B, e.g., as an interior-most layer thereof. This laminate structure 110B may have any of the features described above in conjunction with FIGS. 2-4, including: (i) a fabric 112 (e.g., knit, woven, non-woven, etc.) having an inner face and an outer face, and (ii) a film 118 including at least one fluid impervious layer chosen from a polyurethane layer and a thermoplastic polyurethane layer. The film 118 is adhesively bonded to the inner face of the fabric 112 to form the laminate structure 110B, e.g., by a “full” layer of adhesive 116 (e.g., as shown in FIG. 2) or by intermittently applied adhesive 116 (e.g., as shown in FIG. 3).

In addition to the laminate structure 110B, the garment component 600 of FIGS. 6A-6F includes an exterior layer 410B that includes an interior surface (410I, see FIGS. 6C-6E) and an opposite exterior surface (410O, see FIGS. 6C-6E). The exterior layer 410B is fixed with respect to the laminate structure 110B to form a fluid impervious chamber 110D between (i) the film 118 of the laminate structure 110B and (ii) the interior surface 410I of the exterior layer 410B. In these illustrated examples, the exterior layer 410B is formed from a transparent, partially transparent (semi-transparent), or translucent material (e.g., a TPU material). Thus, the exterior layer 410B is not readily apparent in the plan views of FIGS. 6A-6B, but it is shown in FIGS. 6C-6F.

The garment component 600 of FIGS. 6A-6F differs from the garment component 500 of FIGS. 5A-5E in the tether member. While the example of FIGS. 5A-5E includes a single layer tether member (i.e., sheet member 520), the garment component 600 of FIGS. 6A-6F includes a two layer tether member 620 located at least partially within the fluid impervious chamber 110D. Specifically, this example tether member 620 includes: (a) a first sheet member 622 having a first surface 622A and a second surface 622B opposite the first surface, and (b) a second sheet member 624 having a third surface 624A facing the second surface 622B and a fourth surface 624B opposite the third surface 624A. See FIGS. 6C-6F. Sheet members 622 and/or 624 may be stretchable and/or unstretchable. Sheet member 622 and sheet member 624 may span the same or different areas of the fluid impervious chamber 110D (e.g., including partially overlapping, totally overlapping, spaced apart, and/or abutting) and one or both of sheet members 622 and 624 may extend over any portion or proportion of the area inside seam 408, including up to 100% of the area inside seam 408.

As some examples, in some regions of the tether member 620: (a) the first surface 622A of sheet member 622 is bonded to the first film 118 (also called a “first side bonded region” herein), (b) the fourth surface 624B of sheet member 624 is bonded to the interior surface 410I of the exterior layer 410B (also called a “second side bonded region” herein), and (c) the second surface 622B of the first sheet member 622 is unbonded to the third surface 624A of the second sheet member 624. See Region D in FIGS. 6A-6E. The Region D bonds may be formed by adhesives and/or in an adhesive-free manner. In areas of the tether member 620 at or around Region D, when the garment component 600 is changed to the inflated configuration (e.g., FIGS. 6D and 6E), the sheet members 622 and 624 will pull apart from one another due to their bonds with the first film 118 and the interior surface 410I, respectively, and their lack of bonds to one another.

Additionally or alternatively, as some examples, in some regions of the tether member 620: (a) the first surface 622A of sheet member 622 will be unbonded to the first film 118, (b) the fourth surface 624B of sheet member 624 will be unbonded to the interior surface 410I of the exterior layer 410B, and (c) the second surface 622B of the first sheet member 622 will be bonded to the third surface 624A of the second sheet member 624 (also called an “intermediate bonded region” herein). See Region E in FIGS. 6A-6E. The Region E bonds may be formed by adhesives and/or in an adhesive-free manner. In areas of the tether member 620 at or around Region E, when the garment component 600 is changed to the inflated configuration (e.g., FIGS. 6D and 6E), the sheet members 622 and 624 will remain closer together due to their bonds, sheet member 622 may pull away from film 118, and sheet member 624 may pull away from the interior surface 410I.

Additionally or alternatively, as some additional examples, in some regions of the tether member 620: (a) the first surface 622A of sheet member 622 is bonded to the first film 118, (b) the fourth surface 624B of sheet member 624 is bonded to the interior surface 410I of the exterior layer 410B, and (c) the second surface 622B sheet member 622 is bonded to the third surface 624A of sheet member 624. The bonds may have a structure like that shown in Region F in FIGS. 6A, 6B, and 6F, which form a “complete bonded region.” The Region F bonds may be formed by adhesives and/or in an adhesive-free manner. Region F bonds of this type also may be used to attach other components to garment component 500, such as areas for mounting a pocket component, area for mounting hardware, other desired seam areas, etc.

Other bonding connections between sheet members 622 and 624, the laminate structure 110B, and/or the exterior layer 410B are possible. For example, surface 622A may be bonded to film 118, surface 622B and surface 624A may be bonded together, and surface 624B may remain unbonded to inner surface 410I at one or more regions of the tether member 620. Additionally or alternatively, surface 622A may be unbonded to film 118, surface 622B and surface 624A may be bonded together, and surface 624B may be bonded to inner surface 410I at one or more regions of the tether member 620. Thus, a wide variety of bonded connections and lack of bonded connections between tether member 620 and the interior and exterior layers of the garment component 600 are possible in various specific examples of this technology.

In some examples, one or more through hole openings that extend completely through the garment component 600 may be formed at the Region F bonds. An example through hole opening is shown at element 600A in FIGS. 6A and 6B. In these structures, the through hole openings 600A extend completely through each of interior laminate component 110B, the exterior layer 410B, and the sheet members 622, 624. Such openings 600A may provide openings for breathability, for ventilation, for mounting other components, etc.

FIGS. 6A-6B further show that the two-layered tether member 620 may include one or more through holes 632 (including one or more slits) extending completely through one or both of the sheet members 622 and 624, e.g.,: (i) from the first surface 622A to the second surface 622B, (ii) from the third surface 624A to the fourth surface 624B, and/or (iii) from the first surface 622A to the fourth surface 624B. In some more specific examples, at least a portion of at least one of these through holes 632 may be located between the Regions D, E, and/or F. When the garment component 600 is changed to the inflated configuration, the through hole(s) 632 may expand in size such that: (a) a portion of the interior surface (e.g., film 118 surface) of the interior laminate component 110B is visible and/or (b) a portion of one or more of surfaces 622B and/or 624A is visible through the exterior layer 410B (if it is transparent, partially transparent, or translucent) and/or through at least a portion of the tether member 620 (e.g., through sheet member 624 and/or through both sheet members 622 and 624). Compare the through holes 632 in FIGS. 6A and 6B.

These structural features of the garment component 600 (e.g., a transparent, partially transparent, or translucent exterior layer 410B, a tether member 620, and through hole opening(s) 632) provide several structural and/or design options for garment products. As some examples, garment components can be designed such that different colors and/or graphics can be viewed when the garment component is changed between: (i) a deflated configuration (e.g., in which the through hole openings 632 within the garment component 600 interior chamber 110D are smaller and/or more closed) and (ii) an inflated configuration (e.g., in which the through hole openings 632 within the garment component 600 interior chamber 110D are larger, widened, and/or more open). These changes can be viewed through the transparent, partially transparent, or translucent exterior layer 410B. As some more specific examples, a color or graphic (e.g., on sheet member 622 and/or laminated structure 110B) may be “revealed” as the garment component 600 inflates and the through hole openings 632 in the tether member 620 open up, unfold, and/or widen. As another example, a color or graphic (e.g., on sheet member 622 and/or sheet member 624) may be “revealed” as the garment component 600 deflates and the through hole openings 632 in the tether member 620 close down and/or fold together.

Thus, in some examples of this technology, when the interior surface (e.g., film 118 surface) of the interior laminate component 110B and/or the surface 622B of the sheet member 622 is/are colored differently from the sheet member 624 and/or include a graphical element (e.g., a logo), that different color and/or graphical element may become more prominently displayed and more visible (e.g., “revealed”) through the transparent/translucent exterior layer 410B and/or through the through hole openings 632 of the tether member 620 as the garment component 600 is inflated. These features can be used to change the color pattern and the visual appearance of the overall garment component 600 as the garment component 600 changes between the deflated configuration and the inflated configuration, e.g., so that this “reveal” occurs upon inflation.

Additionally or alternatively, when the major surface 624B of the sheet member 624 is colored differently from the interior surface of laminate component 110B and/or includes a graphical element (e.g., a logo), that different color and/or graphical element may become more prominently displayed and more apparent through the transparent/translucent exterior layer 410B as the through hole openings 632 of the tether member 620 come together when the garment component 600 is deflated. These features can be used to change the color pattern and the visual appearance of the overall garment component 600 as the garment component 600 changes between the inflated configuration and the deflated configuration, e.g., so that this “reveal” occurs upon deflation.

In the examples of FIGS. 6A-6F, the tether member 620 is fluid permeable, e.g., so that the interior chamber 110D of the garment component 600 is in open fluid communication on opposite sides of the tether member 620 and/or between layers of the tether member 620. This may be accomplished in many different ways. For example, the sheets 622, 624 of the tether member 620 may be made from a fabric or textile sheet material and/or other fluid permeable material. Additionally or alternatively, the through hole openings 632, when present, may provide a suitable level of fluid permeability across the tether member 620 (e.g., if the tether member 620 is otherwise fluid impervious).

The tether member 620 and/or its individual sheet members 622, 624 may cover a wide range of the area of a garment component 600 in different examples of this technology. As some more specific examples, in garment components 600 in which the laminate structure 110B and the interior surface 410I of the exterior layer 410B are fixed with respect to one another at an outer perimeter seam 408: (i) the outer perimeter seam 408 will define an area A1 of the fluid impervious chamber 110D, (ii) an outer perimeter edge of the tether member 620 will define an area A2 of the tether member 620, and (iii) the area A2 will be at least 25% of the area A1 (at least 0.25 × A1), and in some examples, A2 will be at least 0.4 × A1, at least 0.5 × A1, at least 0.6 × A1, at least 0.75 × A1, at least 0.9 × A1, or even at least 0.95 × A1. Additionally or alternatively, in at least some examples, an outer perimeter edge of sheet member 622 of the tether member 620 will define an area A3, and the area A3 will be at least 25% of the area A1 (at least 0.25 × A1), and in some examples, A3 will be at least 0.4 × A1, at least 0.5 × A1, at least 0.6 × A1, at least 0.75 × A1, at least 0.9 × A1, or even at least 0.95 × A1. Additionally or alternatively, in at least some examples, an outer perimeter edge of sheet member 624 of the tether member 620 will define an area A4, and the area A4 will be at least 25% of the area A1 (at least 0.25 × A1), and in some examples, A4 will be at least 0.4 × A1, at least 0.5 × A1, at least 0.6 × A1, at least 0.75 × A1, at least 0.9 × A1, or even at least 0.95 × A1. Sheet members 622 and 624 may be co-expansive (i.e., expand over the same area) or they may cover different (but overlapping) areas.

Additionally or alternatively, in some examples, all of the laminate structure 110B, the interior surface 410I of the exterior layer 410B, and at least a portion of an outer perimeter edge of the tether member 620 (including up to 100% of the outer perimeter edge of the sheet member 622 and/or up to 100% of the outer perimeter edge of the sheet member 624) will be fixed with respect to one another at the outer perimeter seam 408 of the garment component 600.

FIGS. 5A-5E, as described above, include features of garment components 500 with one layer tether members 520, and FIGS. 6A-6F, as described above, include features of garment components 600 with two layer tether members 620. If desired, however, garment components may include tether members with three, four, or even more sheets and/or layers.

FIG. 7 provides a partial cross sectional view of a portion of a garment component 700 with a four layered tether member 720 formed from four sheet members 722, 724, 726, and 728. The sheet members 722, 724, 726, and 728 may be fixed together with one another and/or fixed to the film 118 layer of the interior laminate structure 110B and/or the exterior layer 410B in several different combinations, e.g., in order to control the shape and/or thickness of the garment component 700 when inflated. Individual sheet members 722, 724, 726, and/or 728 may be stretchable or unstretchable.

In areas marked Region G in FIG. 7, sheet member 722 is bonded to sheet 724 and sheets 722 and 724 are otherwise not bonded to other elements of garment component 700. In the area marked Region H in FIG. 7, sheet member 722 is bonded to the film 118 of interior laminate structure 110B but otherwise unbonded to other elements of garment component 700. In the area marked Region I in FIG. 7, sheet member 724 is bonded to sheet member 726, but the sheet members 724 and 726 are otherwise not bonded to other elements of the garment component 700. In areas marked Region J in FIG. 7, sheet member 726 is bonded to sheet 728 and sheets 726 and 728 are otherwise not bonded to other elements of garment component 700. In the area marked Region K in FIG. 7, sheet member 728 is bonded to the interior surface 410I of exterior layer 410B, but otherwise unbonded to other elements of garment component 700.

Other layer bonding combinations are possible in the example of FIG. 7. For example, at one or more areas of the garment component 700, sheet members 722, 724, and 726 could be bonded together and sheet member 728 could remain unbonded. Additionally or alternatively, at one or more areas of the garment component 700, sheet members 724, 726, and 728 could be bonded together and sheet member 722 could remain unbonded.

Also additionally or alternatively, at one or more areas of a garment component 700, all of the interior laminate structure 110B, sheet members 722, 724, 726, and 728, and exterior layer 410B may be bonded together as a “complete bonded region.” Complete bonded regions of this type may be used to attach other components to garment component 500, such as areas for mounting a pocket component, areas for mounting hardware, other desired seam areas, etc. One or more through hole openings (akin to openings 500A and/or 600A described above) may be provided through such complete bonded regions (i.e., through all of the interior laminate structure 110B, sheet members 722, 724, 726, and 728, and exterior layer 410B). Such openings may provide openings for breathability, for ventilation, for mounting other components, etc.

In the example of FIG. 7, the tether member 720 may be fluid permeable, e.g., so that the interior chamber 110D of the garment component 700 is in open fluid communication on opposite sides of the tether member 720 and/or between layers of the tether member 720. This may be accomplished in many different ways. For example, the sheets 722, 724, 726, and 728 of the tether member 720 may be made from a fabric or textile sheet material and/or other fluid permeable material. Additionally or alternatively, through hole openings may be provided through one or more of the sheet members 722, 724, 726, and 728 (akin to through holes 522 and 632 described above), and these through holes may provide a suitable level of fluid permeability across the tether member 720 (e.g., if one or more of the sheet members 722, 724, 726, and 728 are otherwise fluid impervious).

The tether member 720 and/or its individual sheet members 722, 724, 726, 728 may cover a wide range of the area of a garment component 700 in different examples of this technology. As some more specific examples, in garment components 700 in which the laminate structure 110B and the interior surface 410I of the exterior layer 410B are fixed with respect to one another at an outer perimeter seam 408: (i) the outer perimeter seam 408 will define an area A1 of the fluid impervious chamber 110D, (ii) an outer perimeter edge of the tether member 720 will define an area A2 of the tether member 620, and (iii) the area A2 will be at least 25% of the area A1 (at least 0.25 × A1), and in some examples, A2 will be at least 0.4 × A1, at least 0.5 × A1, at least 0.6 × A1, at least 0.75 × A1, at least 0.9 × A1, or even at least 0.95 × A1. Additionally or alternatively, the individual sheets 722, 724, 726, and/or 728 of the tether member 720 may have areas with respect to the area A1 of the fluid impervious chamber 110D that fall within the size ranges described above for sheets 622 and 624 (i.e., each of the individual sheet members 722, 724, 726, and 728 will define an area A3, and the area A3 will be at least 25% of the area A1 (at least 0.25 × A1), and in some examples, A3 will be at least 0.4 × A1, at least 0.5 × A1, at least 0.6 × A1, at least 0.75 × A1, at least 0.9 × A1, or even at least 0.95 × A1. Sheet members 722, 724, 726, and 728 may be co-expansive with one another, or an individual sheet member 722, 724, 726, and/or 728 may cover a different area than one or more of the other sheet members 722, 724, 726, and/or 728 (although some overlapping of the sheet members 722, 724, 726, and/or 728 may be present at least at some areas of the garment component 700).

Additionally or alternatively, in some examples, all of the laminate structure 110B, the interior surface 410I of the exterior layer 410B, and at least a portion of an outer perimeter edge of the tether member 720 (including up to 100% of the outer perimeter edges of one or more of the sheet members 722, 724, 726, and/or 728) will be fixed with respect to one another at the outer perimeter seam 408 of the garment component 600.

While FIGS. 5A-7 illustrate bonded Regions A-J as discrete dots or generally rounded in shape, the bonded Regions A-K (and any other bonded regions) may have different sizes and/or shapes, including elongated linear or curved structures; structures producing text and/or graphical elements; or the like.

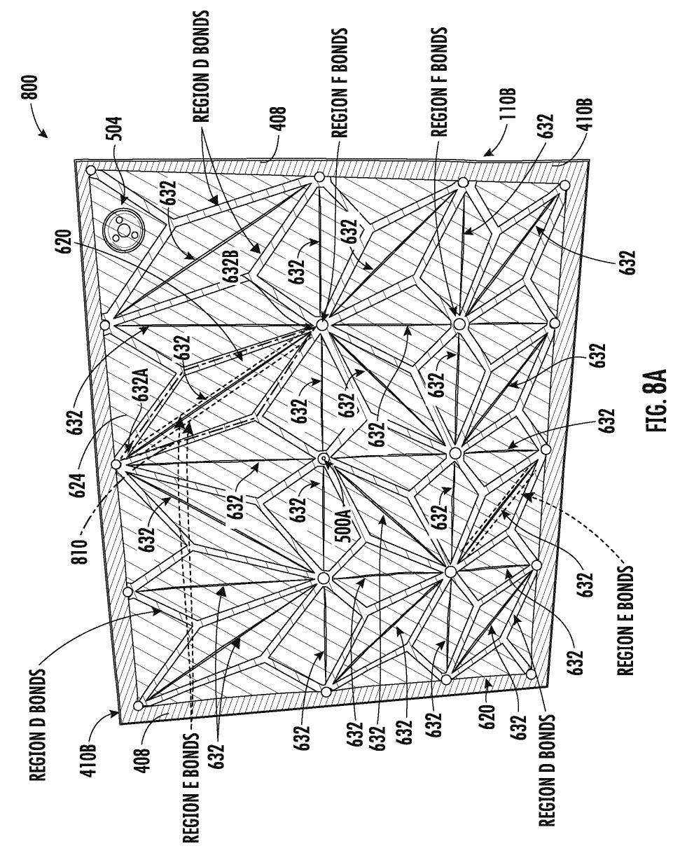

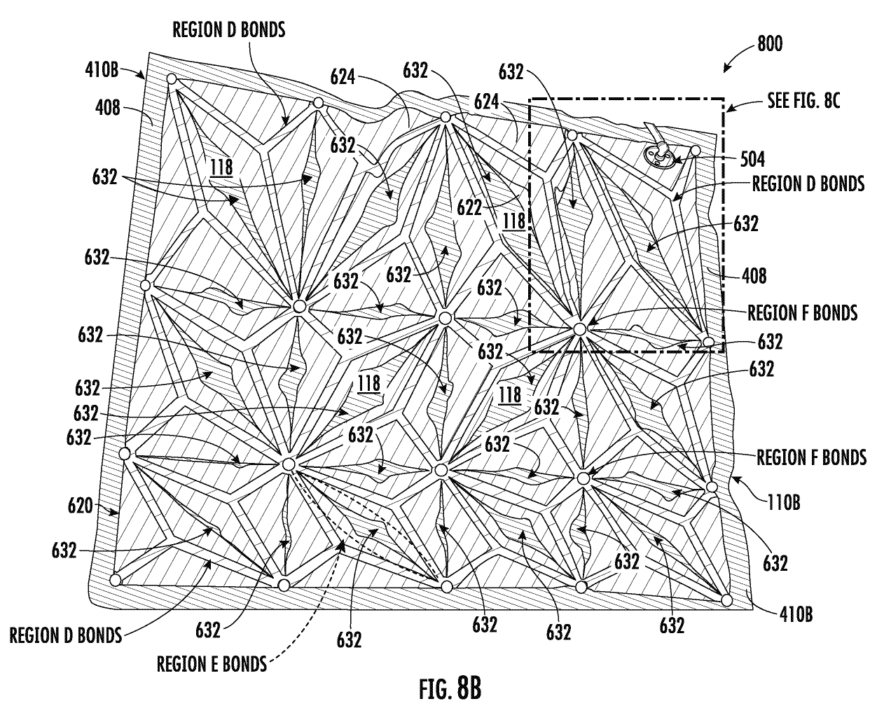

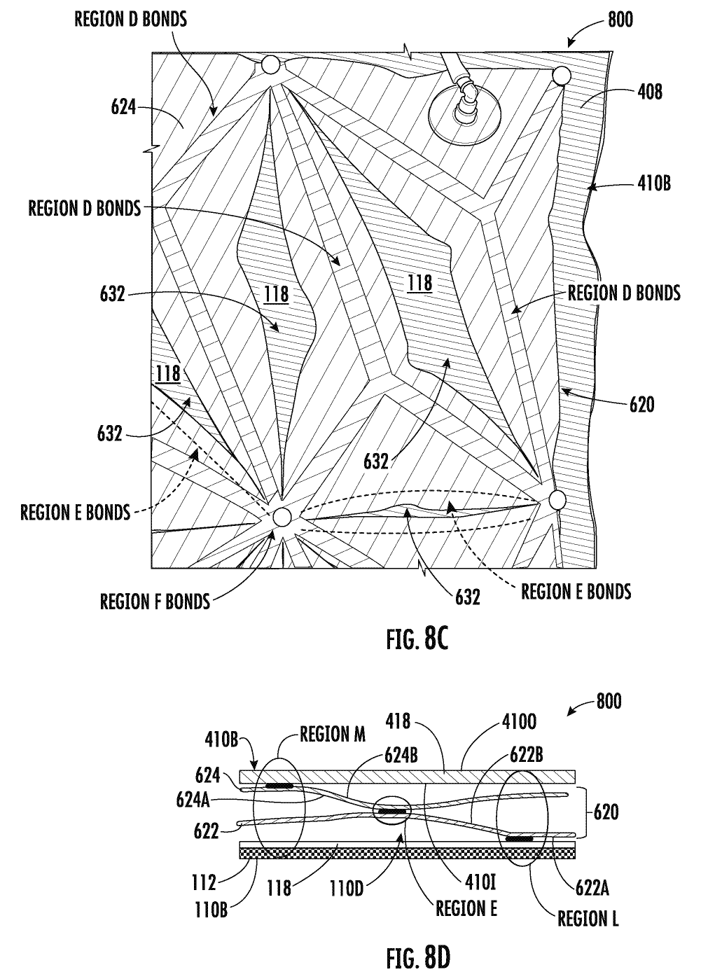

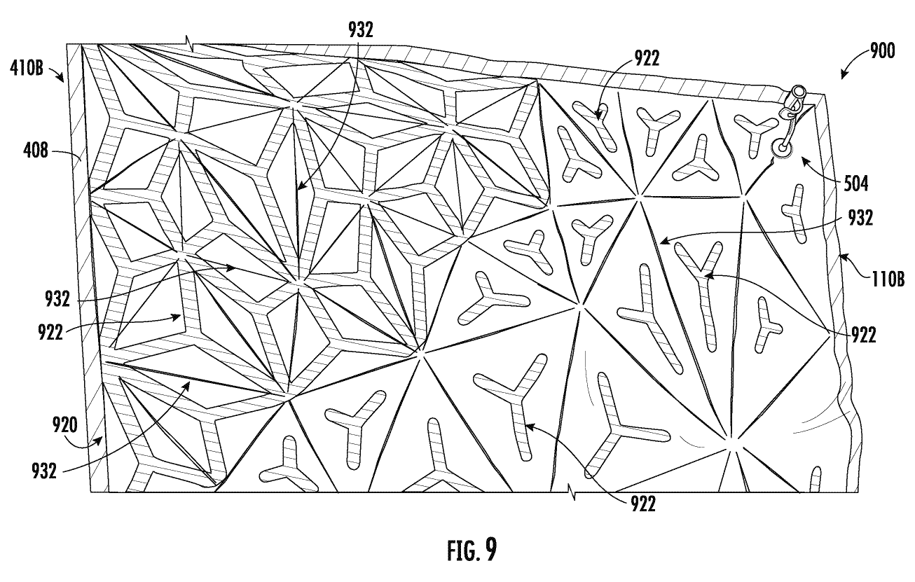

FIGS. 8A-8C provide various views of an example garment component 800 of the type shown in FIGS. 6A-6F with a two layered tether member 620. Where the same reference numbers are used in FIGS. 8A-8D as used in FIGS. 6A-6F and the other figures herein, the same or similar parts are being referenced (including any features, alternatives, and/or options for that part), and much of the overlapping description may be omitted. FIG. 8A shows the garment component 800 in a deflated configuration; FIG. 8B shows the garment component in an inflated configuration; and FIG. 8C provides a close up view of one region to illustrate additional features of this example.

In the example of FIGS. 8A-8C, slits 632 (i.e., through hole openings) are made through the tether member 620 (i.e., through both sheet member 622 and sheet member 624). At the area of the tether member 620 adjacent each of the slits 632, the sheet members 622 and 624 are bonded together, akin to the bonds shown at Region E in FIGS. 6A-6E, with the slit 632 extending along (e.g., parallel to) the bond. One example of these Region E bonds is highlighted in broken lines marked Region E in FIG. 8A. Thus, in the example of FIGS. 8A-8D, the sheet members 622 and 624 are bonded together on opposite sides of each slit 632.

FIGS. 8A-8C further show areas of this garment component 800 that has bonds of the types shown in Region D of FIGS. 6A-6E (where one sheet member 622 of the tether member 620 is bonded to the film 118 (e.g., in a “first side bonded regions”) and one sheet member 624 of the tether member 620 is bonded to the exterior layer 410B (e.g., in a “second side bonded regions”), but the facing surfaces 622B and 624A of the two sheet members 622, 624 are not bonded together (e.g., thus, not a “complete bonded region”).

FIGS. 8A-8C further show several small, round areas having bonds of the types shown in Region F of FIGS. 6A, 6B, and 6F, i.e., complete bonded regions (i.e., with bonds fixing all of the interior laminate structure 110B, each layer of tether member 620, and exterior layer 410B together). Additionally or alternatively, in at least some garment components 800, a through hole opening 500A may be defined completely through laminate structure 110B, the tether member 620, and the exterior layer 410B of the garment component 800. Such opening(s) 500A may be provided, for example, at the Region F type bonds.

In the example of FIGS. 8A-8C, in at least some areas of the garment component 800, the Region D type bonds will form an enclosed perimeter within the interior bladder chamber 110D. Note, for example the enclosed perimeter shown in dot-dash lines at reference number 810 in FIG. 8A. At least at some areas within this enclosed perimeter 810, all of the first surface 622A and the second surface 622B of the first sheet member 622 of the tether member 620 and the third surface 624A and the fourth surface 624B of the second sheet member 624 of the tether member 620 may remain unbonded (e.g., unbonded to one another, unbonded to the film 118, and unbonded to the exterior layer 410B).

Alternatively, in some examples, at least some portion(s) of the Region D type bonds of one or more of the enclosed perimeters of the garment component 800 may be replaced with Region F type bonds (i.e., complete bonded regions).

As further shown in the example of FIG. 8A, in at least some of the enclosed perimeters formed by Region D type bonds (and/or Region F type bonds), one or more through hole openings 632 may be defined through the tether member 620 (e.g., through one or both of sheet members 622 and/or 624). In the illustrated example shown at reference number 810 in FIG. 8A, the through hole opening 632 is a single elongated slit opening 632 extending completely through the tether member 620. The elongated slit opening 632 of this specific example extends from a first location 632A at or proximate to the enclosed perimeter formed by the Region D type bonds (and/or Region F type bonds), across the unbonded region of the tether member 620, and to a second location 632B at or proximate to the enclosed perimeter formed by the Region D type bonds (and/or Region F type bonds).

While not a requirement, at least some of the through hole openings 632 may be made through Region E type bonds where the second surface 622B of the first sheet member 622 is bonded to the first surface 624A of the second sheet member 624 of the tether member, e.g., as shown in FIG. 6E. In some examples, however, the through hole openings 632 may be provided at least at some locations where surface 622B and surface 624A are unbonded (e.g., so that surfaces 622B and 624A can separate from one another, e.g., when the garment component 800 is in the inflated configuration.

A comparison of FIGS. 8A and 8B illustrate this garment component 800 transitioning between the deflated configuration (FIG. 8A) and the inflated configuration (FIG. 8B). As is evident, when in the inflated configuration, the slits 632 through the tether member 620 may pull apart to expose the surface of film 118 and/or laminate structure 110B through the slits 632 and through the exterior layer 410B. When the film 118 surface and/or interior laminate structure 110B is differently colored (the more dense upper left-to-lower right hatching in FIGS. 8A-8C) from the tether member 620 color (the less dense, steep lower left-to-upper right hatching in FIGS. 8A-8D) and the exterior layer 410B is transparent, partially transparent, and/or translucent, the color patterns and/or other visual appearance features displayed change significantly between the deflated configuration (FIG. 8A) and the inflated configuration (FIGS. 8B-8C) (e.g., with the interior surface of the interior laminate structure 110B exposed at more locations in the inflated configuration).

As shown in FIGS. 8B and 8C, in this illustrated example, when the fluid impervious chamber 110D is in the inflated configuration, the tether member 620 forms pockets of fluid (e.g., air) between unbonded portions of sheet member 622 and sheet member 624 (e.g., at areas that do not include bonds of the types shown in Regions E and F of FIGS. 6A-6F). In at least some areas, these pockets of fluid are located between the second surface 622B of the first sheet member 622 and the first surface 624A of the second sheet member 624. Additionally, in at least some areas, these pockets of fluid will be located within larger pockets of fluid (e.g., air) that form the interior bladder chamber 110D (between film 118 and the interior surface 410I of exterior layer 410B). Fluid (e.g., air) can enter the spaces between sheet member 622 and sheet member 624 in this illustrated example at least in part due to gas permeability of the sheet members 622, 624 (e.g., textile materials).

As further shown in the example of FIGS. 8A-8C, when the exterior layer 410B comprises a transparent, partially transparent, or translucent material, at least the tether member 620 is visible through the exterior layer 410B. Additionally, in this example, when the garment component 800 is in the inflated configuration (FIGS. 8B and 8C), an interior of the laminate structure 110B (e.g., film 118) is visible through the plurality of openings 632 and through the exterior layer 410B. The visibility/perceivability of the interior of the laminate structure 110B (e.g., film 118) can be enhanced, e.g., if the interior of the laminate structure 110B (e.g., film 118) has a different color from the tether member 620.

As further evident from a comparison of FIG. 8A and 8B, the change between the deflated configuration (FIG. 8A) and the inflated configuration (FIG. 8B) of this example results in a change in an amount of the laminate structure 110B visible through the exterior layer 410B and/or creates a color pattern and/or graphical element change that is visible through the exterior layer 410B.

Additionally or alternatively, as shown in FIG. 8D, in at least some areas of a garment component 800, the area(s) between the enclosed perimeter(s) formed by the Region D type bonds (and/or Region F type bonds) may include one or more areas in which the tether member 620 further includes: (a) the first surface 622A of the first sheet member 622 bonded to the first film 118, (b) the second surface 622B of the first sheet member unbonded to the first surface 624A of the second sheet member 624, and (c) the fourth surface 624B of the second sheet member 624 unbonded to the interior surface 410I of the exterior layer 410B. See Region L in FIG. 8D (which may be considered “first side bonded regions”). Still additionally or alternatively, in at least some areas of a garment component 800, the area(s) between the enclosed perimeter(s) formed by the Region D type bonds (and/or Region F type bonds) may include area in which the tether member 620 further includes: (a) the first surface 622A of the first sheet member 622 unbonded to the first film 118, (b) the second surface 622B of the first sheet member 622 unbonded to the first surface 624A of the second sheet member 624, and (c) the fourth surface 624B of the second sheet member 624 bonded to the interior surface 410I of the exterior layer 410B. See Region M in FIG. 8D (which may be considered “second side bonded regions”). These Region L type bonds and/or Region M type bonds, when present, may be formed by an adhesive and/or in an adhesive free manner. These additional bond types provide additional avenues for potential bladder chamber 110D shape, thickness control, and/or visual appearance change features.

FIG. 9 illustrates another example garment component 900 in accordance with aspects of this technology. The example garment component 900 of FIG. 9 is similar to those described above in conjunction with FIGS. 6A-6F and 8A-8D, including a laminate structure 110B as an interior-most layer thereof. The laminate structure 110B is the steep, upper right-to-lower left hatched material most visible at the outer perimeter seam 408 of the garment component 900 in the view shown in FIG. 9. This laminate structure 110B may have any of the features described above in conjunction with FIGS. 2-4, including: (i) a fabric 112 (e.g., knit, woven, non-woven, etc.) having an inner face and an outer face, and (ii) a film 118 including at least one fluid impervious layer chosen from a polyurethane layer and a thermoplastic polyurethane layer. The film 118 is adhesively bonded to the inner face of the fabric 112 to form the laminate structure 110B, e.g., by a “full” layer of adhesive 116 (e.g., as shown in FIG. 2) or by intermittently applied adhesive 116 (e.g., as shown in FIG. 3).

In addition to the laminate structure 110B, the garment component 900 of FIG. 9 includes an exterior layer 410B that includes an interior surface (410I, see FIGS. 5C and 5D) and an opposite exterior surface (410O, see FIGS. 5C and 5D). The exterior layer 410B is fixed with respect to the laminate structure 110B at outer perimeter seam 408 to form a fluid impervious chamber 110D between (i) the film 118 of the laminate structure 110B and (ii) the interior surface of the exterior layer 410B. In these illustrated examples, the exterior layer 410B is formed from a transparent, partially transparent, or translucent material (e.g., a TPU material). Thus, the exterior layer 410B is not readily apparent in the view of FIG. 9

The garment component 900 of FIG. 9 further includes a tether member 920 having one or more layers and/or any of the features of tether members described above (e.g., tether members 520, 620, and 720). The tether member 920 is the includes the unhatched are in the view of FIG. 9. Bonds between at least the outermost layer of the tether member 920 and the exterior layer 110B are shown in FIG. 9 at reference number 922 (with upper left-to-lower right hatching in FIG. 9). These bonds 922 may be one or more of Region B, Region C, Region D, Region F, Region K, and/or Region M type bonds described above.

As shown on the left top of FIG. 9, the bonds 922 may form perimeters, e.g., of the types described above in conjunction with perimeters 810 shown in FIG. 8A. These perimeters may form polygons (e.g., triangles, quadrilaterals, pentagons, hexagons, etc.,), ovals, ellipses, irregular shapes, etc. Further, as also shown in FIG. 9, at least some of these perimeter bonded regions may include one or more through holes 932 (e.g., slits) extending through one or more layers of the tether member 920. The through holes 932 are not very prominent in FIG. 9 because the garment component 900 is in the deflated configuration. But when the garment component 900 is changed to the inflated configuration, these through holes 932 will open up, akin to the changes at through holes 832 shown in a comparison of FIGS. 8A with 8B and 8C.

As further shown in FIG. 9, bonds 922 of the types described above are not limited to bonds forming enclosed perimeters. Rather, as shown at the right side and toward the bottom of FIG. 9, at least some of the bonds 922 may be formed as shapes that do not extend to form a completely enclosed perimeter. Rather, some of these specifically illustrated bonds 922 are formed as line segments, e.g., in spaced apart Y-shaped structures. Additionally or alternatively, other bond 922 shapes are possible in other specific examples of this technology, including line segment shapes; curved shapes; broken line or curved arrangements of multiple bond segments; bond segments forming letters, numbers, or other graphical elements; etc.

FIG. 9 further illustrates that a single garment component 900 may have a variety of different tether member bonded region sizes, shapes, orientations, and/or arrangements.

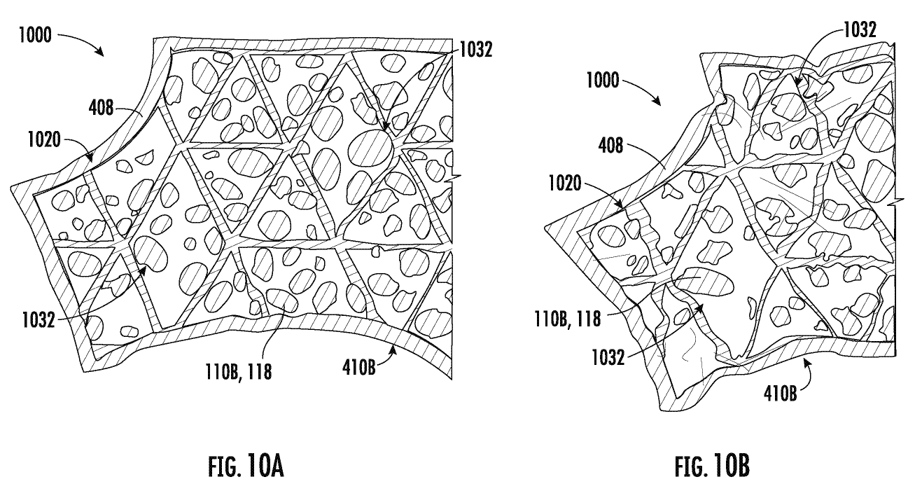

Several of the examples described above show the through hole openings 522, 632, and 932 in the tether members 520, 620, 720, 920 in the shape of elongated slits. Other shapes are possible. FIGS. 10A and 10B show an example garment component 1000 similar to those described above in conjunction with FIGS. 6A-6F, 8A-8D, and 9, e.g., with an interior laminate structure 110B (the steep, upper right-to-lower left hatched material); an exterior layer 410B that is transparent, partially transparent, and/or translucent; and a tether member 1020 having one or more layers (the unhatched area). In the example of FIGS. 10A and 10B, however, the openings 1032 in the tether member 1020 have a more open and/or rounded shape. FIGS. 10A and 10B further illustrate example changes in appearance when switching between the deflated configuration (FIG. 10A) and the inflated configuration (FIG. 10B).

Many different configurations of tether members (e.g., 520, 620, 720, 920, 1020), bonding of their layers to one another and to other elements of a garment component, and/or through hole openings may be provided in specific examples of this technology. For example, tether members may include one or more layers, and individual layers may extend over different portions and/or proportions of an inflatable interior chamber 110D. The layers further may include different colors and/or different graphical elements to further change features of the overall garment components.

Additionally or alternatively, in at least some examples of this technology, tether members of the types described herein (e.g., 520, 620, 720, 920, 1020) may be made from a stretchable material (e.g., an elastomeric material). As a more specific example, when the garment component is in a deflated configuration, the tether member may be unstretched or in a first stretched condition. Then, when converted to the inflated configuration, the inflation may cause the tether member to stretch as compared to its condition in the deflated configuration and/or to further stretch to a second stretched condition (with greater stretch than the first stretch condition). Such stretching, when it occurs, may cause through hole openings in the tether member to stretch and change in size, potentially adding additional differences to the appearance changes that may be realized in accordance with some examples of this technology.

Additionally or alternatively, the tether member(s) may be bonded to the interior laminate structure 110B and/or the exterior layer 410B in a wide variety of different bonding patterns, including, but not limited to: bonding regions of various different sizes and/or shapes; bonding patterns that create desired shapes, graphical elements, patterns, etc.; etc. Still additionally or alternatively, openings (e.g., 522, 632, 932, 1032) in tether members may be provided in a variety of different sizes, shapes, and/or arrangements; openings in tether members may be provided to display or reveal desired underlying features within the garment component, such as features on another layer of the tether member and/or features on the interior-most surface of the interior laminate structure 110B; etc. Additionally or alternatively, the relative positioning of bonds and/or openings in a garment structure can be varied to change the visual perception and/or to change size and/or shape of the inflatable chamber 110D. Thus, aspects of this technology may provide a wide variety of visual and/or aesthetic appearances while the garment component can still provide the desired thermal insulative and/or other functions.

Aspects of this technology may provide many advantages and advantageous features. For example, inflatable bladder chambers 110D in garments 100 and garment components 600, 700, 800 in accordance with aspects of this technology may include different bonding patterns (e.g., bond sizes and or shapes) and/or different bond area densities on opposite sides of the of one or more intermediate sheet member or tethers. For example, for tether member 620 shown in FIGS. 6C-6F and 8D: (a) a first bonding pattern or bond area density may be provided between sheet member 622 and laminated component 110B (the pattern or density of the first side bonded regions or Region L bonds), and (b) a second, different bonding pattern or bond area density may be provided between sheet member 624 and layer 410B (the pattern or density of the second side bonded regions or Region M bonds). Similar changes or differences may be provided between the bond patterns and/or bond densities at Region H and Region K for tether member 720 in the garment component 700 of FIG. 7. When inflated, the inflatable bladder chamber portion on one side of a tether member 620 (between sheet member 622 and laminated component 110B) or 720 may inflate to a different height or thickness than the inflatable bladder chamber portion on the other side of tether member 620 (between sheet member 624 and layer 410B) or 720. Adjustment and changes to the bond patterns and/or densities in these Region L and/or Region M type bonds in tether member 620 or to the bond patterns and/or densities in these Region H and/or Region K type bonds in tether member 720 can be used to control the shape of the garment component 600, 700, 800 when inflated and/or control the thickness of the overall inflated bladder chamber 110D (e.g., an overall thickness from interior laminated component 110B to layer 410B).

Additionally or alternatively, on a single side of a sheet member 520 or tether member 620, 720, the bonding pattern and/or bond area density may be altered at different areas or regions of the garment 100 or garment component 600, 700, 800. This feature also may allow control of the overall thickness of the inflated bladder chamber 110D. As a more specific example, for garments formed as upper body garments (e.g., jackets, vests, etc.) that include inflatable bladder chambers 110D on the sides and/or sleeves (if any), reduced Region H, Region K, Region L, and/or Region M bond spacings and/or greater bond area densities may be provided at the sides of the torso and/or at the insides of the sleeves. As another example, for garments formed as lower body garments (e.g., pants, shorts, etc.) that include inflatable bladder chambers 110D on the leg sleeves, reduced Region H, Region K, Region L, and/or Region M bond spacings and/or greater bond area densities may be provided at the inner sides of the leg sleeves (e.g., between the thigh, knee, and/or calf regions the insides of the leg sleeves). Reduced bond spacings and/or greater bond area densities at one or more of these areas may help reduce the inflatable bladder chamber 110D thicknesses at these facing area, e.g., so that the wearer’s arms and/or legs are positioned and/or move more naturally. Additionally or alternatively, reduced interior bond spacings and/or greater bond area densities at one or more of these areas may help reduce the arms or arm sleeves from continually rubbing against the side regions of the garment and/or prevent the insides of the leg sleeves from rubbing together, potentially reducing noise and/or wear.

Garment components 500, 600, 700, 800, 900, and 1000 of the types described herein may form complete garment structures and/or panels or components of garment structures having one or more additional components (e.g., garment components of the types described above in conjunction with FIGS. 1A-1F). Additionally or alternatively, garment components 500, 600, 700, 800, 900, and 1000 of the types described herein may be joined with other garment components, including other garment components having inflatable bladder chambers. When joined with other garment components having inflatable bladder chambers, the garment component(s) 500, 600, 700, 800, 900, and 1000 of the types described herein may be joined together and/or joined with other garment components having inflatable bladder chambers in a fluid communicating manner (i.e., so that fluid transfers between two or more garment components having inflatable bladder chambers that have been connected together). This may be accomplished in any suitable manner, including in any of the manners described in any of U.S. Provisional Patent Appln. Nos. 63/677,693, 63/677,708, 63/677,842, 63/677,870, 63/726,392, 63/726,394, 63/726,399, and 63/726,427.

Additionally or alternatively, aspects of this technology may be useful to provide a quick visual indication of the inflation status of one or more garment components in a garment structure and/or of an overall garment structure.

While FIGS. 1A-10B illustrate garment components and garments having various different features, such as bladder chamber sizes, shapes, and specific configurations and/or tether members having various sizes, shapes, and specific configurations and/or tether member openings having various sizes, shapes, and specific configurations, many variations in features are possible without departing from this technology. The specifically illustrated garments, garment components, their bladders and bladder chamber portions, their tether members and the openings therein, and/or other features could be varied widely in size, shape, configuration, and/or aesthetic appearance while still providing the desired functions and/or properties described above.

For avoidance of doubt, this application includes within its scope at least the subject matter described in the following “Clause Sets” and numbered “Clauses:”

### CLAUSE SET A

Clause 1. A garment component, comprising: (A) a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric; (B) a first layer having an interior surface and an exterior surface located opposite the interior surface, the first layer comprising a transparent, partially transparent, or translucent material, wherein the interior surface is fixed with respect to the laminate structure to form a fluid impervious chamber between the first film and the first layer; and (C) a sheet member located within the fluid impervious chamber, the sheet member including: (i) a first major surface, (ii) a second major surface located opposite the first major surface, (iii) a first region where the first major surface is bonded to the first film and the second major surface is unbonded to the interior surface of the first layer, (iv) a second region where the second major surface is bonded to the interior surface of the first layer and the first major surface is unbonded to the first film, and (v) an expanse region of the sheet member extending between the first region and the second region.

Clause 2. The garment component according to Clause 1, wherein the fluid impervious chamber is changeable between an inflated configuration and a deflated configuration, wherein in the inflated configuration, the first region is separated from the second region by a first distance, wherein in the deflated configuration the first region is separated from the second region by a second distance, and wherein the first distance is greater than the second distance.

Clause 3. The garment component according to Clause 2, wherein the sheet member includes one or more through holes extending completely through the sheet member from the first major surface to the second major surface.

Clause 4. The garment component according to Clause 3, wherein at least a portion of a first through hole of said one or more through holes is located between the first region and the second region in the expanse region of the sheet member.

Clause 5. The garment component according to Clause 3, wherein at least a first through hole of said one or more through holes comprises a first elongated slit extending completely through the sheet member from the first major surface to the second major surface.

Clause 6. The garment component according to Clause 5, wherein at least a portion of the first elongated slit is located within the expanse region of the sheet member.

Clause 7. The garment component according to any one of Clauses 3 to 6, wherein when the fluid impervious chamber is in the inflated configuration, a first portion of an interior of the laminate structure is visible through the first layer and through at least one of the one or more through holes defined through the sheet member.

Clause 8. The garment component according to any one of Clauses 2 to 7, wherein when the fluid impervious chamber is in the inflated configuration, a first portion of an interior of the laminate structure is visible through the first layer and through the sheet member.

Clause 9. The garment component according to Clause 7 or 8, wherein the first portion of the interior of the laminate structure has a different color from a color of the sheet member that is visible through the first layer.

Clause 10. The garment component according to any one of Clauses 2 to 9, wherein a change between the inflated configuration and the deflated configuration creates a change in an amount of the laminate structure visible through the first layer.

Clause 11. The garment component according to Clause 10, wherein the change in the amount of laminate structure visible through the first layer creates a color pattern change visible through the first layer.

Clause 12. The garment component according to Clause 1, wherein the sheet member includes one or more through holes extending completely through the sheet member from the first major surface to the second major surface.

Clause 13. The garment component according to Clause 12, wherein at least a portion of a first through hole of the one or more through holes is located in the expanse region of the sheet member.

Clause 14. The garment component according to Clause 12, wherein at least a first through hole of said one or more through holes comprises a first elongated slit extending completely through the sheet member from the first major surface to the second major surface.

Clause 15. The garment component according to Clause 14, wherein at least a portion of the first elongated slit is located within the expanse region of the sheet member.

Clause 16. The garment component according to any one of Clauses 12 to 15, wherein a first portion of an interior of the laminate structure is visible through the first layer and through at least one of the one or more through holes defined through the sheet member at least when the fluid impervious chamber is in an inflated configuration.

Clause 17. The garment component according to any one of Clauses 1 or 12 to 16, wherein a first portion of an interior of the laminate structure is visible through the first layer and through the sheet member at least when the fluid impervious chamber is in an inflated configuration.

Clause 18. The garment component according to Clause 16 or 17, wherein the first portion of the interior of the laminate structure has a different color from a color of the sheet member that is visible through the first layer.

Clause 19. The garment component according to any one of Clauses 1 to 18, wherein the garment component includes fluid communication within the fluid impervious chamber to locations on opposite sides of the sheet member.

Clause 20. The garment component according to any one of Clauses 1 to 19, wherein the sheet member comprises a textile sheet.

Clause 21. The garment component according to any one of Clauses 1 to 20, wherein the sheet member is gas permeable.

Clause 22. The garment component according to any one of Clauses 1 to 21, wherein the laminate structure and the interior surface of the first layer are fixed with respect to one another at an outer perimeter seam.

Clause 23. The garment component according to Clause 22, wherein the outer perimeter seam defines a first area of the fluid impervious chamber, wherein an outer perimeter edge of the sheet member defines a second area, and wherein the second area is at least 25% of the first area.

Clause 24. The garment component according to any one of Clauses 1 to 21, wherein the laminate structure, the interior surface of the first layer, and at least a portion of an outer perimeter edge of the sheet member are fixed with respect to one another at an outer perimeter seam.

### CLAUSE SET B

Clause 1. A garment component, comprising: (A) a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric; (B) a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and (C) a tether member located within the fluid impervious chamber, the tether member including a first sheet member having a first surface and a second surface opposite the first surface, and a second sheet member having a third surface facing the second surface and a fourth surface opposite the third surface. The tether member may further include: (i) a first region located within the fluid impervious chamber where the first surface is bonded to the first film and the fourth surface is bonded to the interior surface of the first layer, wherein the first region extends to define a first perimeter, and (ii) a second region located within the first perimeter, wherein in at least a portion of the second region, the first surface, the second surface, the third surface, and the fourth surface are unbonded.

Clause 2. The garment component according to Clause 1, wherein a through hole opening is defined through the tether member in the second region.

Clause 3. The garment component according to Clause 1, wherein an elongated slit is defined through the tether member in the second region.

Clause 4. The garment component according to Clause 3, wherein the elongated slit extends from a first location at or proximate to the first perimeter, across the second region, to a second location at or proximate to the first perimeter.

Clause 5. The garment component according to any one of Clauses 1 to 4, wherein in at least a first portion of the first region, the second surface is bonded to the third surface.

Clause 6. The garment component according to Clause 5, wherein a through hole opening is defined completely through laminate structure, the tether member, and the first layer within the first portion of the first region.

Clause 7. The garment component according to any one of Clauses 1 to 6, wherein when the fluid impervious chamber is in the inflated configuration, fluid separates the second surface from the third surface within at least some portions of the second region.

Clause 8. The garment component according to any one of Clauses 1 to 7, wherein the first layer comprises a transparent, partially transparent, or translucent material such that at least the tether member is visible through the first layer.

Clause 9. The garment component according to Clause 8, wherein the tether member includes a plurality of openings extending completely the tether member from the first surface to the fourth surface, wherein an interior of the laminate structure is visible through the plurality of openings and the first layer at least when the fluid impervious chamber is in the inflated configuration.

Clause 10. The garment component according to Clause 9, wherein at least a first opening of the plurality of openings comprises a first elongated slit extending completely through the tether member.

Clause 11. The garment component according to Clause 9 or 10, wherein the interior of the laminate structure that is visible through the plurality of openings and the first layer has a different color from a color of the tether member that is visible through the first layer.

Clause 12. The garment component according to any one of Clauses 8 to 11, wherein a change between the inflated configuration and the deflated configuration creates a change in an amount of the laminate structure visible through the first layer.

Clause 13. The garment component according to any one of Clauses 1 to 12, wherein a change between the inflated configuration and the deflated configuration creates a color pattern change visible through the first layer.

Clause 14. The garment component according to any one of Clauses 1 to 13, wherein within a portion of the second region, the tether member further includes a region where the first surface is bonded to the first film and the fourth surface is unbonded to the interior surface of the first layer.

Clause 15. The garment component according to any one of Clauses 1 to 14, wherein within a portion of the second region, the tether member further includes a region where the first surface is unbonded to the first film and the fourth surface is bonded to the interior surface of the first layer.

Clause 16. The garment component according to any one of Clauses 1 to 15, wherein the garment component includes fluid communication within the fluid impervious chamber to locations on opposite sides of the tether member.

Clause 17. The garment component according to any one of Clauses 1 to 16, wherein at least one of the first sheet member and the second sheet member comprises a textile sheet.

Clause 18. The garment component according to any one of Clauses 1 to 17, wherein the tether member is gas permeable.

Clause 19. The garment component according to any one of Clauses 1 to 18, wherein the laminate structure and the interior surface of the first layer are fixed with respect to one another at an outer perimeter seam.

Clause 20. The garment component according to Clause 19, wherein the outer perimeter seam defines a first area of the fluid impervious chamber, wherein an outer perimeter edge of the tether member defines a second area, and wherein the second area is at least 25% of the first area.

Clause 21. The garment component according to any one of Clauses 1 to 20, wherein the laminate structure, the interior surface of the first layer, and at least a portion of an outer perimeter edge of the tether member are fixed with respect to one another at an outer perimeter seam.

### CLAUSE SET C

Clause 1. A garment component, comprising: (A) a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric; (B) a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and (C) a tether member located within the fluid impervious chamber, the tether member including a first sheet member having a first surface and a second surface opposite the first surface, and a second sheet member having a third surface facing the second surface and a fourth surface opposite the third surface. The tether member further may include: (i) a plurality of complete bonded regions located within the fluid impervious chamber, wherein at the complete bonded regions (a) the first surface is bonded to the first film, (b) the fourth surface is bonded to the interior surface of the first layer, and (c) the second surface is bonded to the third surface, (ii) a plurality of first side bonded regions located within the fluid impervious chamber, wherein at the first side bonded regions (a) the first surface is bonded to the first film and (b) the second surface is unbonded to the third surface; and (iii) a plurality of second side bonded regions located within the fluid impervious chamber, wherein at the second side bonded regions (a) the second surface is unbonded to the third surface and (b) the fourth surface is bonded to the first layer.

Clause 2. The garment component according to Clause 1, wherein when the fluid impervious chamber is in the inflated configuration, fluid separates the first sheet member from the second sheet member at locations between the plurality of first side bonded regions and the plurality of second side bonded regions.

Clause 3. The garment component according to Clause 1 or 2, wherein when the fluid impervious chamber is in the inflated configuration: (a) fluid separates the first surface from the first film at locations between the plurality of complete bonded regions and the plurality of first side bonded regions and (b) fluid separates the fourth surface from the interior surface of the first layer at locations between the plurality of complete bonded regions and the plurality of second side bonded regions.

Clause 4. The garment component according to any one of Clauses 1 to 3, wherein the tether member further includes a plurality of intermediate bonded regions located within the fluid impervious chamber, wherein at the intermediate bonded regions (a) the second surface is bonded to the third surface, (b) the first surface is unbonded to the first film, and (c) the fourth surface is unbonded to the first layer.

Clause 5. The garment component according to any one of Clauses 1 to 4, wherein the first layer comprises a transparent, partially transparent, or translucent material such that at least the tether member is visible through the first layer.

Clause 6. The garment component according to Clause 5, wherein the tether member includes a plurality of openings extending completely the tether member from the first surface to the fourth surface, wherein an interior of the laminate structure is visible through the plurality of openings and the first layer at least when the fluid impervious chamber is in the inflated configuration.

Clause 7. The garment component according to Clause 6, wherein at least a first opening of the plurality of openings comprises a first elongated slit extending completely through the tether member.

Clause 8. The garment component according to Clause 6 or 7, wherein the interior of the laminate structure that is visible through the plurality of openings and the first layer has a different color from a color of the tether member that is visible through the first layer.

Clause 9. The garment component according to any one of Clauses 5 to 8, wherein a change between the inflated configuration and the deflated configuration creates a change in an amount of the laminate structure visible through the first layer.

Clause 10. The garment component according to any one of Clauses 1 to 9, wherein a change between the inflated configuration and the deflated configuration creates a color pattern change visible through the first layer.

Clause 11. The garment component according to any one of Clauses 1 to 10, wherein the garment component includes fluid communication within the fluid impervious chamber to locations on opposite sides of the tether member.

Clause 12. The garment component according to any one of Clauses 1 to 11, wherein at least one of the first sheet member and the second sheet member comprises a textile sheet.

Clause 13. The garment component according to any one of Clauses 1 to 12, wherein the tether member is gas permeable.

Clause 14. The garment component according to any one of Clauses 1 to 13, wherein the laminate structure and the interior surface of the first layer are fixed with respect to one another at an outer perimeter seam.

Clause 15. The garment component according to Clause 14, wherein the outer perimeter seam defines a first area of the fluid impervious chamber, wherein an outer perimeter edge of the tether member defines a second area, and wherein the second area is at least 25% of the first area.

Clause 16. The garment component according to any one of Clauses 1 to 15, wherein the laminate structure, the interior surface of the first layer, and at least a portion of an outer perimeter edge of the tether member are fixed with respect to one another at an outer perimeter seam.

### CLAUSE SET D

Clause 1. A garment component, comprising: (A) a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric; (B) a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and (C) a tether member located within the fluid impervious chamber, the tether member including a first sheet member having a first surface and a second surface opposite the first surface, and a second sheet member having a third surface facing the second surface and a fourth surface opposite the third surface. The tether member further may include: (i) a plurality of first side bonded regions located within the fluid impervious chamber, wherein at the first side bonded regions (a) the first surface is bonded to the first film and (b) the second surface is unbonded to the third surface; (ii) a plurality of second side bonded regions located within the fluid impervious chamber, wherein at the second side bonded regions (a) the second surface is unbonded to the third surface and (b) the fourth surface is bonded to the first layer; and (iii) a plurality of intermediate bonded regions located within the fluid impervious chamber, wherein at the intermediate bonded regions (a) the second surface is bonded to the third surface, (b) the first surface is unbonded to the first film, and (c) the fourth surface is unbonded to the first layer.

Clause 2. The garment component according to Clause 1, wherein when the fluid impervious chamber is in the inflated configuration, fluid separates the first sheet member from the second sheet member at locations between the plurality of intermediate bonded regions.

Clause 3. The garment component according to Clause 1 or 2, wherein when the fluid impervious chamber is in the inflated configuration: (a) fluid separates the first surface from the first film at locations between the plurality of first side bonded regions and (b) fluid separates the fourth surface from the interior surface of the first layer at locations between the plurality of second side bonded regions.

Clause 4. The garment component according to any one of Clauses 1 to 3, wherein the first layer comprises a transparent, partially transparent, or translucent material such that at least the tether member is visible through the first layer.

Clause 5. The garment component according to Clause 4, wherein the tether member includes a plurality of openings extending completely the tether member from the first surface to the fourth surface, wherein an interior of the laminate structure is visible through the plurality of openings and the first layer at least when the fluid impervious chamber is in the inflated configuration.

Clause 6. The garment component according to Clause 5, wherein at least a first opening of the plurality of openings comprises a first elongated slit extending completely through the tether member.

Clause 7. The garment component according to Clause 5 or 6, wherein the interior of the laminate structure that is visible through the plurality of openings and the first layer has a different color from a color of the tether member that is visible through the first layer.

Clause 8. The garment component according to any one of Clauses 4 to 7, wherein a change between the inflated configuration and the deflated configuration creates a change in an amount of the laminate structure visible through the first layer.

Clause 9. The garment component according to any one of Clauses 1 to 8, wherein a change between the inflated configuration and the deflated configuration creates a color pattern change visible through the first layer.

Clause 10. The garment component according to any one of Clauses 1 to 9, wherein the garment component includes fluid communication within the fluid impervious chamber to locations on opposite sides of the tether member.

Clause 11. The garment component according to any one of Clauses 1 to 10, wherein at least one of the first sheet member and the second sheet member comprises a textile sheet.

Clause 12. The garment component according to any one of Clauses 1 to 11, wherein the tether member is gas permeable.

Clause 13. The garment component according to any one of Clauses 1 to 12, wherein the laminate structure and the interior surface of the first layer are fixed with respect to one another at an outer perimeter seam.

Clause 14. The garment component according to Clause 13, wherein the outer perimeter seam defines a first area of the fluid impervious chamber, wherein an outer perimeter edge of the tether member defines a second area, and wherein the second area is at least 25% of the first area.

Clause 15. The garment component according to any one of Clauses 1 to 14, wherein the laminate structure, the interior surface of the first layer, and at least a portion of an outer perimeter edge of the tether member are fixed with respect to one another at an outer perimeter seam.

### CLAUSE SET E

Clause 1. A garment component, comprising: (A) a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric; (B) a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and (C) a tether member located within the fluid impervious chamber, the tether member including a first outermost surface and a second outermost surface. The tether member further may include: (i) a first region located within the fluid impervious chamber where the first outermost surface is bonded to the first film and the second outermost surface is bonded to the interior surface of the first layer, wherein the first region extends to define a first perimeter, and (ii) a second region located within the first perimeter, wherein in at least a portion of the second region, when the fluid impervious chamber is in the inflated configuration, the first outermost surface and the second outermost surface are separated from one another by open space within the fluid impervious chamber.

Clause 2. A garment component, comprising: (A) a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric; (B) a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and (C) a tether member located within the fluid impervious chamber, the tether member including a first outermost surface and a second outermost surface. The tether member further may include: (i) a plurality of complete bonded regions located within the fluid impervious chamber, wherein at the complete bonded regions (a) the first outermost surface is bonded to the first film, (b) the second outermost surface is bonded to the interior surface of the first layer, and (c) the first outermost surface is fixed with respect to the second outermost surface, (ii) a plurality of first side bonded regions located within the fluid impervious chamber, wherein at the first side bonded regions (a) the first outermost surface is bonded to the first film and (b) the second outermost surface is movable with respect to the first outermost surface; and (iii) a plurality of second side bonded regions located within the fluid impervious chamber, wherein at the second side bonded regions (a) the second outermost surface is bonded to the first layer and (b) the first outermost surface is movable with respect to the second outermost surface.

Clause 3. A garment component, comprising: (A) a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric; (B) a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and (C) a tether member located within the fluid impervious chamber, the tether member including a first outermost surface, a second outermost surface, and two or more intermediate surfaces. The tether member further may include: (i) a plurality of first side bonded regions located within the fluid impervious chamber, wherein at the first side bonded regions (a) the first outermost surface is bonded to the first film and (b) at least one intermediate surface is movable with respect to the first outermost surface; (ii) a plurality of second side bonded regions located within the fluid impervious chamber, wherein at the second side bonded regions (a) the second outermost surface is bonded to the first layer and (b) at least one intermediate surface is movable with respect to the second outermost surface; and (iii) a plurality of intermediate bonded regions located within the fluid impervious chamber, wherein at the intermediate bonded regions (a) at least two of the intermediate surfaces are bonded together, (b) the first outermost surface is movable with respect to the at least two of the intermediate surfaces that are bonded together, and (c) the second outermost surface is movable with respect to the at least two of the intermediate surfaces that are bonded together.

Clause 4. The garment component according to any one of Clauses 1 to 3, wherein a through hole opening is defined through the tether member.

Clause 5. The garment component according to any one of Clauses 1 to 3, wherein an elongated slit is defined through the tether member.

Clause 6. The garment component according to any one of Clauses 1 to 5, wherein the first layer comprises a transparent, partially transparent, or translucent material such that at least the tether member is visible through the first layer.

Clause 7. The garment component according to Clause 6, wherein the tether member includes a plurality of openings extending completely the tether member from the first outermost surface to the second outermost surface, and wherein an interior of the laminate structure is visible through the plurality of openings and the first layer at least when the fluid impervious chamber is in the inflated configuration.

Clause 8. The garment component according to Clause 7, wherein at least a first opening of the plurality of openings comprises a first elongated slit extending completely through the tether member.

Clause 9. The garment component according to Clause 7 or 8, wherein the interior of the laminate structure that is visible through the plurality of openings and the first layer has a different color from a color of the tether member that is visible through the first layer.

Clause 10. The garment component according to any one of Clauses 6 to 9, wherein a change between the inflated configuration and the deflated configuration creates a change in an amount of the laminate structure visible through the first layer.

Clause 11. The garment component according to any one of Clauses 1 to 10, wherein a change between the inflated configuration and the deflated configuration creates a color pattern change visible through the first layer.

Clause 12. The garment component according to any one of Clauses 1 to 11, wherein the garment component includes fluid communication within the fluid impervious chamber to locations on opposite sides of the tether member and between the first outermost surface and the second outermost surface of the tether member.

Clause 13. The garment component according to any one of Clauses 1 to 12, wherein the tether member includes a plurality of textile sheets.

Clause 14. The garment component according to any one of Clauses 1 to 13, wherein the tether member is gas permeable.

Clause 15. The garment component according to any one of Clauses 1 to 14, wherein the laminate structure and the interior surface of the first layer are fixed with respect to one another at an outer perimeter seam.

Clause 16. The garment component according to Clause 15, wherein the outer perimeter seam defines a first area of the fluid impervious chamber, wherein an outer perimeter edge of the tether member defines a second area, and wherein the second area is at least 25% of the first area.

Clause 17. The garment component according to any one of Clauses 1 to 16, wherein the laminate structure, the interior surface of the first layer, and at least a portion of an outer perimeter edge of the tether member are fixed with respect to one another at an outer perimeter seam.

### II. Conclusion

The present invention is disclosed above and in the accompanying drawings with reference to a variety of example structures. The purpose served by the disclosure, however, is to provide examples of the various features and concepts related to the invention, not to limit the scope of the invention. One skilled in the relevant art will recognize that numerous variations and modifications may be made to the embodiments described above without departing from the scope of the present invention, as defined by the appended claims.

1. A garment component, comprising:
a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric;
a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and
a tether member located within the fluid impervious chamber, the tether member including a first sheet member having a first surface and a second surface opposite the first surface, and a second sheet member having a third surface facing the second surface and a fourth surface opposite the third surface, the tether member further including:
(i) a plurality of first side bonded regions located within the fluid impervious chamber, wherein at the first side bonded regions (a) the first surface is bonded to the first film and (b) the second surface is unbonded to the third surface;
(ii) a plurality of second side bonded regions located within the fluid impervious chamber, wherein at the second side bonded regions (a) the second surface is unbonded to the third surface and (b) the fourth surface is bonded to the first layer; and
(iii) a plurality of intermediate bonded regions located within the fluid impervious chamber, wherein at the intermediate bonded regions (a) the second surface is bonded to the third surface, (b) the first surface is unbonded to the first film, and (c) the fourth surface is unbonded to the first layer.

2. The garment component according to claim 1, wherein when the fluid impervious chamber is in the inflated configuration, fluid separates the first sheet member from the second sheet member at locations between the plurality of intermediate bonded regions.

3. The garment component according to claim 1, wherein when the fluid impervious chamber is in the inflated configuration: (a) fluid separates the first surface from the first film at locations between the plurality of first side bonded regions and (b) fluid separates the fourth surface from the interior surface of the first layer at locations between the plurality of second side bonded regions.

4. The garment component according to claim 1, wherein the first layer comprises a transparent, partially transparent, or translucent material such that at least the tether member is visible through the first layer.

5. The garment component according to claim 4, wherein the tether member includes a plurality of openings extending completely the tether member from the first surface to the fourth surface, wherein an interior of the laminate structure is visible through the plurality of openings and the first layer at least when the fluid impervious chamber is in the inflated configuration.

6. The garment component according to claim 5, wherein at least a first opening of the plurality of openings comprises a first elongated slit extending completely through the tether member.

7. The garment component according to claim 5, wherein the interior of the laminate structure that is visible through the plurality of openings and the first layer has a different color from a color of the tether member that is visible through the first layer.

8. The garment component according to claim 1, wherein a change between the inflated configuration and the deflated configuration creates a color pattern change visible through the first layer.

9. The garment component according to claim 1, wherein the garment component includes fluid communication within the fluid impervious chamber to locations on opposite sides of the tether member.

10. The garment component according to claim 1, wherein at least one of the first sheet member and the second sheet member comprises a textile sheet.

11. A garment component, comprising:
a laminate structure including: (i) a first fabric having an inner face and an outer face, and (ii) a first film including at least one fluid impervious layer chosen from a polyurethane layer and a thermoplastic polyurethane layer, wherein the first film is adhesively bonded to the inner face of the first fabric;
a first layer having an interior surface and an exterior surface located opposite the interior surface, wherein the interior surface is fixed with respect to the laminate structure to form a fluid impervious chamber between the first film and the first layer, wherein the fluid impervious chamber is changeable between an inflated configuration and a deflated configuration; and
a tether member located within the fluid impervious chamber, the tether member including a first sheet member having a first surface and a second surface opposite the first surface, and a second sheet member having a third surface facing the second surface and a fourth surface opposite the third surface, the tether member further including:
(i) a plurality of complete bonded regions located within the fluid impervious chamber, wherein at the complete bonded regions (a) the first surface is bonded to the first film, (b) the fourth surface is bonded to the interior surface of the first layer, and (c) the second surface is bonded to the third surface,
(ii) a plurality of first side bonded regions located within the fluid impervious chamber, wherein at the first side bonded regions (a) the first surface is bonded to the first film and (b) the second surface is unbonded to the third surface; and
(iii) a plurality of second side bonded regions located within the fluid impervious chamber, wherein at the second side bonded regions (a) the second surface is unbonded to the third surface and (b) the fourth surface is bonded to the first layer.

12. The garment component according to claim 11, wherein when the fluid impervious chamber is in the inflated configuration, fluid separates the first sheet member from the second sheet member at locations between the plurality of first side bonded regions and the plurality of second side bonded regions.

13. The garment component according to claim 11, wherein when the fluid impervious chamber is in the inflated configuration: (a) fluid separates the first surface from the first film at locations between the plurality of complete bonded regions and the plurality of first side bonded regions and (b) fluid separates the fourth surface from the interior surface of the first layer at locations between the plurality of complete bonded regions and the plurality of second side bonded regions.

14. The garment component according to claim 11, wherein the tether member further includes a plurality of intermediate bonded regions located within the fluid impervious chamber, wherein at the intermediate bonded regions (a) the second surface is bonded to the third surface, (b) the first surface is unbonded to the first film, and (c) the fourth surface is unbonded to the first layer.

15. The garment component according to claim 11, wherein the first layer comprises a transparent, partially transparent, or translucent material such that at least the tether member is visible through the first layer.

16. The garment component according to claim 15, wherein the tether member includes a plurality of openings extending completely the tether member from the first surface to the fourth surface, wherein an interior of the laminate structure is visible through the plurality of openings and the first layer at least when the fluid impervious chamber is in the inflated configuration.

17. The garment component according to claim 16, wherein at least a first opening of the plurality of openings comprises a first elongated slit extending completely through the tether member.

18. The garment component according to claim 16, wherein the interior of the laminate structure that is visible through the plurality of openings and the first layer has a different color from a color of the tether member that is visible through the first layer.

19. The garment component according to claim 11, wherein a change between the inflated configuration and the deflated configuration creates a color pattern change visible through the first layer.

20. The garment component according to claim 11, wherein the garment component includes fluid communication within the fluid impervious chamber to locations on opposite sides of the tether member.
